(19) United States
(12) Patent Application Publication
(10) Pub. No.: US 2004/0139400 A1
(43) Pub. Date: Jul. 15, 2004

(54) Method and apparatus for displaying and viewing information

(76) Inventors: Scott Gerald Allam, Edgewater, MD (US); Gary Charies Staas, Scotts Valley, CA (US); David Carl Morrison, Frisco, TX (US); James Edward Fay III, Neenah, WI (US)

Correspondence Address: James E. Fay, 1096 Reed Street, Neenah, WI, 54956, US

(21) Appl. No.: 10/691,927

(22) Filed: Oct. 22, 2003

Related U.S. Application Data
(60) Provisional application No. 60/420,803, filed on Oct. 23, 2002.

(51) Int. Cl. G06F 17/21

(52) U.S. Cl. 715/526

(57) ABSTRACT

A method and system for displaying and viewing electronic information using a computerized interface is disclosed.

### CROSS REFERENCE TO RELATED APPLICATIONS

The present application claims the benefit of U.S. Provisional Patent Application Ser. No. 60/420,803 entitled METHOD AND APPARATUS FOR DISPLAYING AND VIEWING ELECTRONIC INFORMATION, filed on Oct. 23, 2002.

### BACKGROUND OF THE INVENTION

Recently, there has been an explosion in the market for electronic texts. Viewing textual information in electronic form while preserving physical aspects of the electronic text, however, is a challenge. Electronic documents, nevertheless, have a number of advantages over paper documents including their ease of transmission, their compact storage, and their ability to be edited and/or electronically manipulated, searched, and the ability to add annotations such as notes, highlights and bookmarks as tags to the document that do not necessarily change the document. Further annotations can be shared and used in collaboration in ways that are not possible with “paper” documents. An electronic document typically has information content (such as text, graphics, and images), as in a physical document, and formatting information that directs how the content is to be displayed. Further, electronic documents now include sound, full motion video, and other multimedia content that are not available in a physical document. Because of these advantages, the demand for electronic texts has grown.

A type of electronic document that has gained widespread acceptance among authors, distributors, and publishers is Portable Document Format (PDF) developed by Adobe Systems, Inc., San Jose, Calif. PDF is a page description file format which describes the visual appearance of a document's physical page, including fonts and special characters, images, and layout. PDF keeps the design of a page fixed and communicates the physical structure through visual cues such as fonts and font size, indentation, and placement on a page or screen. Further, PDF allows for sophisticated typography, non-Roman alphabets, and mathematical and chemical equations. Thus, PDF files are a preferred file format for distributing electronic text for the intent of printing and are widely used in the publishing industry.

One problem with the electronic viewing of PDF documents and other page description or document file formats is that pages in files are dependent upon the concept of a paper page. Since pages in prior art page description or document file formats retain the concept of a physical page, pages are difficult to resize without loss of legibility and may not adapt to screens of different sizes. Because of this limitation, working with and viewing a page in PDF is cumbersome. Pages may be best viewed in full-page view. However, when viewed in full-page view, the text is too small to read. For a computer user to view a letter-sized page on a screen and still be able to read the text, the computer user must zoom closer and scroll up and down or left and right to fully understand the information on the representation of the physical page. This makes the task of reading a PDF on-screen quite awkward.

Electronic documents, and particularly textbooks, often span many pages, more often hundreds of pages. Some prior art page description or document file formats, such as PDF, have illegible text when the page is in full view and a reader may have to zoom closer and subsequently scroll down to read text in different parts of the page. This can make reading of the electronic document difficult. Further, a reader of the electronic textbook may become frustrated, print out a hard copy of the file and discontinue using the electronic text. Having to scroll down to finish reading a column on a page, scrolling up to read another column, and scrolling down to finish reading the second column for each and every page in the electronic text is quite frustrating. Being able to read an electronic textbook without having to scroll down a page is desirable.

Another type of electronic document is one that adheres to Open eBook (OEB) standards that are derived from Extensible Markup Language (XML) and HyperText Markup Language (HTML) markup tags. Open eBook provides for a set of rules that allow for coding of electronic information and for providing an interface so that electronic reader software is able to interpret the electronic information. OEB utilizes XML to create descriptions of text data that can be embedded in the text file itself and provides coding practice requirements for the XML descriptions in order for an electronic document to be OEB compliant. A number of manufacturers have come together to support the OEB standard.

One problem with formatting documents adhering to the OEB standard is that it requires a considerable understanding of text markup. Requiring such understanding has proven to be difficult for many authors and publishers who think in terms of the appearance of the printed page. Another problem with OEB is that conversion of electronic information to the OEB standard is difficult and cumbersome. More significant problems are that OEB has the same limitations as that of XML and HTML. That is, OEB does not allow for sophisticated typography, does not allow for control over screen sizes and resolutions, and has limited control over element placement. Further, OEB does not have a provision for complex mathematical or chemical equations. Also, since OEB does not preserve the format of the physical page, a computer user reading an electronic text using the OEB standard may not know how many physical pages he or she has read. Physical information such as the size of the book in pages, the number of pages in a chapter, and other physical properties of a book are lost when a physical book has been converted to the OEB standard.

While PDF and other page description or document file formats may perform better in these areas, as mentioned above, these formats also have restrictions which limit their use for viewing electronic information. By being limited to the definition of a physical page, prior art formats do not allow for textual information to be easily viewed by a computer user. Because of many of these limitations of the prior art products, consumers may prefer physical copies rather than an electronic version.

Improved displaying and viewing systems and methods would be desirable, particularly for electronic documents that present a large amount of electronic information.

Various aspects of the invention are described in more detail in the following Drawings and Detailed Description of the Invention.

### BRIEF DESCRIPTION OF THE DRAWINGS

FIG. 1 is a block diagram illustrating a general overview of an embodiment of the present invention.

FIG. 2 is a system diagram illustrating an example environment for FIG. 1.

FIG. 3 is an illustration of an example “Enhanced Interactive Window,” (used herein as “EIW”) of FIG. 1.

FIG. 4 is an illustration of an example picture and caption for the EIW of FIG. 1.

FIG. 5 is an illustration of a menu used in EIW of FIG. 1.

FIG. 6 is an illustration of bookmarks used to initiate extraction of page elements for use in the EIW of FIG. 1.

FIG. 7 is an illustration of audiovisual clips used in EIW of FIG. 1.

FIG. 8 is an illustration of a link in EIW of FIG. 1.

FIG. 9 is a flow diagram of a structure tree used in the information manager of FIG. 1.

FIG. 10 is an illustration of the relationship between a document page and the EIW of FIG. 1.

FIG. 11 is another illustration of the relationship between a document page and the EIW of FIG. 1.

FIG. 12 is a flow diagram of a method for displaying and viewing electronic information.

FIG. 13 is a flow diagram of the process of following markup annotations.

FIG. 14 is a flow diagram for creating a study guide for FIG. 1.

FIG. 15 is an example of a study guide created by the process of FIG. 14.

FIG. 16 is an illustration of a note tool of FIG. 1.

FIG. 17 is an illustration of a dictionary tool of FIG. 1.

FIG. 18 is an illustration of an annotation.

FIG. 19 is an illustration of an annotation.

FIG. 20 is an illustration of a window with a horizontal viewing zone.

FIG. 21 is an illustration of a window with a horizontal viewing zone.

FIG. 22 is an illustration of a window with a horizontal viewing zone.

### DETAILED DESCRIPTION OF THE INVENTION

Reference will now be made in detail to one or more embodiments of the invention, examples of which are illustrated in the drawings. Each example and embodiment is provided by way of explanation of the invention, and not meant as a limitation of the invention. For example, features illustrated or described as part of one embodiment may be used with another embodiment to yield still a further embodiment. It is intended that the invention include these and other modifications and variations as coming within the scope and spirit of the invention.

Generally, the present invention is for methods and apparatus for displaying and viewing electronic information. In one aspect, the method comprises displaying a representation of a physical page from an electronic document, extracting information from the representation, and presenting the extracted information in an enhanced interactive window. As used herein, “physical page” is defined as a piece of paper that has top, bottom, and side margins. Many physical pages typically make up a book. An illustrative embodiment of the invention is depicted graphically in the drawings and is explained below.

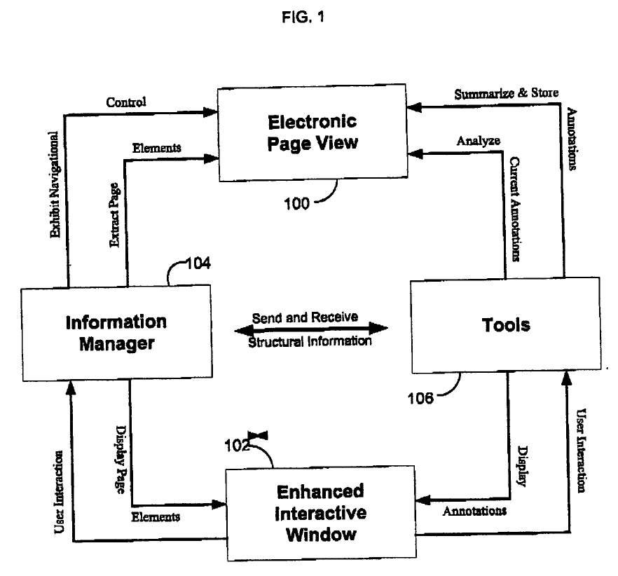

Referring now to the drawings, FIG. 1 diagrammatically illustrates an embodiment of a system for management of electronic information in accordance with the present invention. Briefly, the electronic information management system may be described as comprising an electronic page view 100, an Enhanced Interactive Window (as used herein, “EIW”) 102, an interactive window that displays multiple levels of document headers along with annotations in context with the headers (as used herein, SmartNotes) and multiple methods of preparing the information for this window, an Information Manager 104, and tools 106. The EIW 102, SmartNotes, Information Manager 104 and tools 106 when used together enhance the readability, navigation, summarization and usability of the electronic page view 100. The EIW 102 depicts electronic information from the electronic page view 100 in an easy to read format and provides the user access to the tools 106. Further, the EIW 102 enables the user to exhibit navigational control over the electronic page view 100 by turning pages, zooming to pertinent page elements, hyperlinking to related topics and initiating actions within the electronic page view 100. SmartNotes may display the structure of a document or book using levels of headers and be a way to keep individual pages and even collections of pages in perspective to the entire document. SmartNotes may also be a way to see annotations in context with the document's headers, but without the clutter of unwanted document content. The information manager 104 organizes information from an electronic document, preferably in a page description or document file format, and maintains a link to the EIW 102 by analyzing relationships between the electronic document and the EIW 102 through a structure tree and word analysis. The tools 106 allow the user to access the information in the information manager 104 and to add user created annotations. The information manager 104 will store, either internally or externally to the electronic document, information that defines the relationship of the user created annotation to the electronic page view 100. Tools include, but are not limited to, software and hardware applications such as a typed and styled notes tools, highlighting, file appending, bookmarking, search, changing font size, skim, dictionary, and study guide creation. Further, various aspects of the present invention can be implemented in either hardware or software, or both.

### I. Illustrative Environment

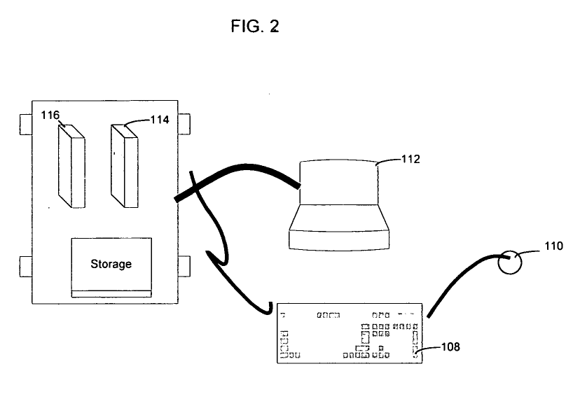

An embodiment of the present invention may be employed and used in conjunction with any computer system, such as a personal desktop computer, a notebook computer, a computer network, a personal digital assistant (PDA), a cellular telephone, or a mobile/wireless assistant. For example, as shown in FIG. 2, a computer system such as a personal desktop computer including a monitor, a keyboard, a mouse, random access memory (RAM), and storage in the form of a hard disk. In addition, the computer may also include a floppy disk, a CD-ROM drive, read-only-memory, and a modem, as are well known in the art. The electronic information management system may also be implemented on computing platforms that emerge in the future, but in the embodiment described below it is implemented on a desktop computer. Specifically, a cellular telephone or a wireless digital assistant may also be an appropriate computing platform for an embodiment of the present invention.

An embodiment of the present invention operates on top of computer operating software currently available on a number of platforms, such as Microsoft Windows™, Apple MacOS™, Linux™, and Sun Solaris™. The computer system may be running Windows 98, Windows NT, or equivalent, Palm OS, WindowsCE, Windows ME, Windows 2000, Windows XP or equivalent, or an operating system used on Apple or Sun Computers. An embodiment of the present invention is not limited to a particular operating system or computer system to function.

An embodiment of the present invention is provided as software, which may be loaded from floppy disks, from a CD-ROM, over a network, or from any other suitable storage media. The software may be loaded onto the hard disk drive of a computer in a manner that is known to those skilled in the art.

The display may be any display that may be viewed by the computer user. For example, it may be a cathode ray display, or a dual scan display on a notebook computer, or an active matrix display on a notebook computer. The display may optionally be touch sensitive.

The RAM may be any conventional RAM that is known to those skilled in the art. The same is true of the Read Only Memory (ROM) of the computer. The permanent storage may be in the form of conventional hard drives, read-write CD-ROMs, disks, or any other medium that stores data when the computer is not operating. In order to enter data or other information, the user may use a keyboard, either alone or in conjunction with a pointing device, such as a mouse, or a pointer used on a touch sensitive screen. Alternatively, the information may be entered by voice command using any conventional voice command software package.

In addition to a personal computer, this invention may be practiced using a network computer, a “dumb terminal” on a multi-user system, or an Internet or Intranet computer, in which software is resident on the Internet or Intranet, rather than stored on a hard disk on a personal computer. Further, the computer may either operate in a stand-alone mode or over a network.

While the above embodiment describes a single computer, it will be understood that the functionality may be distributed over a plurality of computers. For example, in a distributed architecture, an embodiment of the present invention may be implemented as a Web server.

### II. Operation of an Illustrative Embodiment of the Present Invention

A. Enhanced Interactive Window (“EIW”)

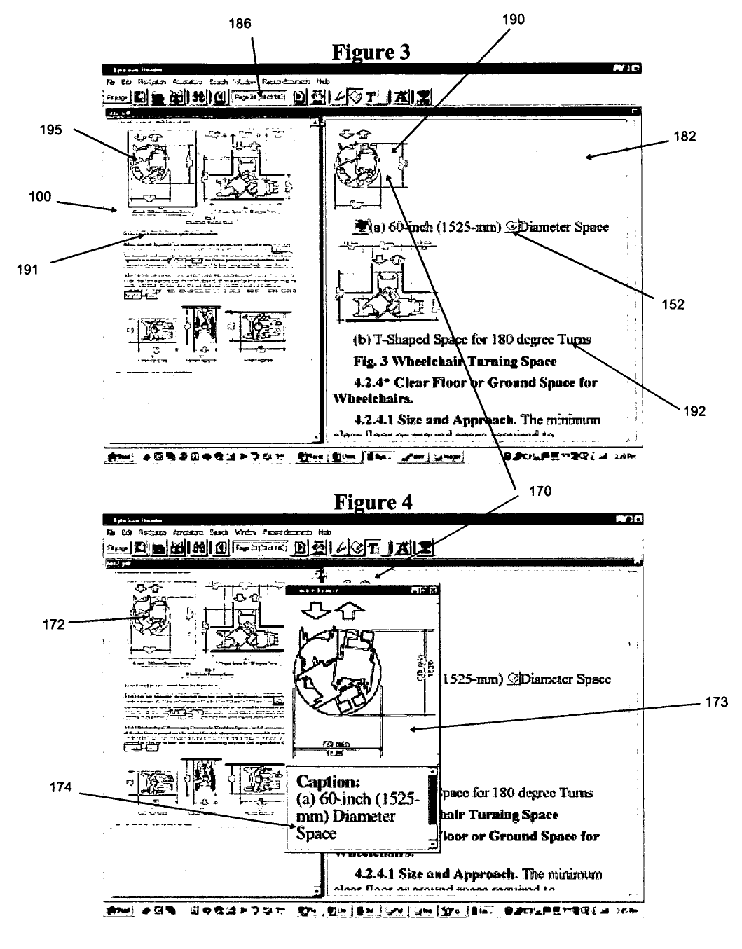

In an illustrative embodiment, the EIW 102 allows for displaying and viewing of electronic information. It contains electronic information from and works in tandem with an electronic document adhering to a page description or document file format, such as the PDF file format. The EIW 102 serves as a control panel for managing information in an electronic document. In FIG. 3, EIW 102 is shown as a graphical user interface and is labeled EIW 182. Electronic page view 100 is shown in graphical form as electronic page view 194. The EIW 182 includes a display area for textual and graphical information, menus and control bars, which are derived from and exhibit navigational control over the electronic page view 194. The text in the display area of the EIW 182 is “free-flowing text,” which means sentences and paragraphs flow without interruption and the line breaks and hyphenation are handled dynamically depending on the font size and column width. Included in the display area of the EIW 182 is an information bar 186 that contains the page number of the physical page being displayed in the electronic page view 194. Although in one embodiment, physical document wide orientation is maintained by displaying the page number in EIW 182, the same information may be presented by displaying thumbnail views representing pages in a book, where thumbnail may be an icon or graphic image. Further, physical orientation may also be maintained by listing current page references in an information palette, listing remaining pages for a particular chapter or section being presented in an information palette, and by using graphical representations including a visual slider bar. The visual slider bar may graphically represent a time line with a begin, end, and a current page marker, so that a reader can visually see where the current page is in relation to the book as a whole or portions of the book, such as a chapter.

During customary reading behavior, a reader starts reading at the top of a column and finishes at the bottom. Likewise, information in the EIW 182 begins at the top of the EIW 182 and does not arbitrarily begin in the middle. Using a page down function, prior art products may force the user to begin reading newly presented text in the middle of the window, because there were not enough lines of text to create a whole column's worth. An illustrative embodiment of the present invention overcomes this limitation. Structuring electronic information by adding white space at the bottom of the window when there are not enough lines of text to make a full column, will assure that new information always begins at the top of the EIW 182.

As shown in FIG. 3, the electronic page view 194 has a green box 191 bounding the text in the paragraph. The box 191 is termed a visual reference and is used to show that the text within the box has been extracted and is displayed in the accompanying display area of the EIW 182. As used herein, the box 191 is termed a “markup annotation.” A markup annotation is a box around elements in the electronic page view 194. Although a green box has been used in FIG. 3, the markup annotation may have been another color. Further, the markup annotation may have been emphasized by other types of visual references including highlighting or other emphasizing means to show that the text within the markup annotation is being displayed in an accompanying display area of the EIW 182.

As shown in FIG. 3, text 192 is highlighted which denotes that the text has been marked for future reference and may have associated information, where the associated information is termed a note. FIG. 3 also depicts picture icon 190 that represents the picture 195 on the electronic page view 194. Pictures may be enlarged and have associated captions that the computer user may want to view. Shown in FIG. 4 is an example screen shot depicting this feature. Clicking on picture icon 170 or picture 172 enlarges the picture 172 associated with the icon 170. In one embodiment, the enlarged picture 172 is displayed in a new window. Clicking on picture icon 170 or the enlarged picture 172 again returns the user to a previously viewed setting which was stored prior to enlarging picture 172. Enlarging picture 172 also displays the text for the picture in another enhanced interactive window 174. In another embodiment, graphics can be displayed as scaled thumbnails in the EIW. The scaling of the thumbnails may be a user-settable function. In addition, graphics may be displayed in an image browser than allows the user to scale the graphics so that even small details can be clearly seen. The image browser also may be used to facilitate copying and pasting of graphics to other documents.

Referring back to FIG. 3, in an illustrative embodiment of the present invention, electronic page view 194 is represented by a page in an electronic document adhering to the PDF file format. Although the PDF file format has been used to represent the physical page, the PDF file format is not meant as a limitation. On the contrary, other document file formats which may describe a page may be suitable, such as HTML or a word processing document format. In addition to other document file formats, other electronic representations of physical pages (whether now known or hereafter devised) may be used to represent the physical page for extraction into an EIW 182. For example, the physical page may be represented by a bitmap or a Shockwave™ ActiveX™ image.

In an alternative embodiment, the EIW 182 may be viewed in a separate window and may be managed by a separate control panel. The EIW 182 may be minimized, maximized, manually re-sized and moved by the computer user. Additionally, multiple EIWs are allowed, where each is a separate entity with unique contents and can be maneuvered independently of each other. In yet another alternative embodiment, the electronic page view 194 may also be viewed in a separate window and may be managed by a separate control panel. In any case, the window for the electronic page view may also be minimized, maximized, manually re-sized and moved by the computer user. Further, viewing the separate windows may be accomplished by other means, such as entering a keystroke or “toggling” to change between the views. In yet another embodiment, the electronic page view may be a small icon of a book with small annotations representing the text that is selected. For example, on a small monitor such as used in PDAs, a flashing square on a book icon may represent a selected annotation while the rest of the monitor is used for displaying the extracted text, such as shown in the display area of the EIW 182 of FIG. 3.

The EIW 182 may also contain icons that represent notes that may be added to the text.

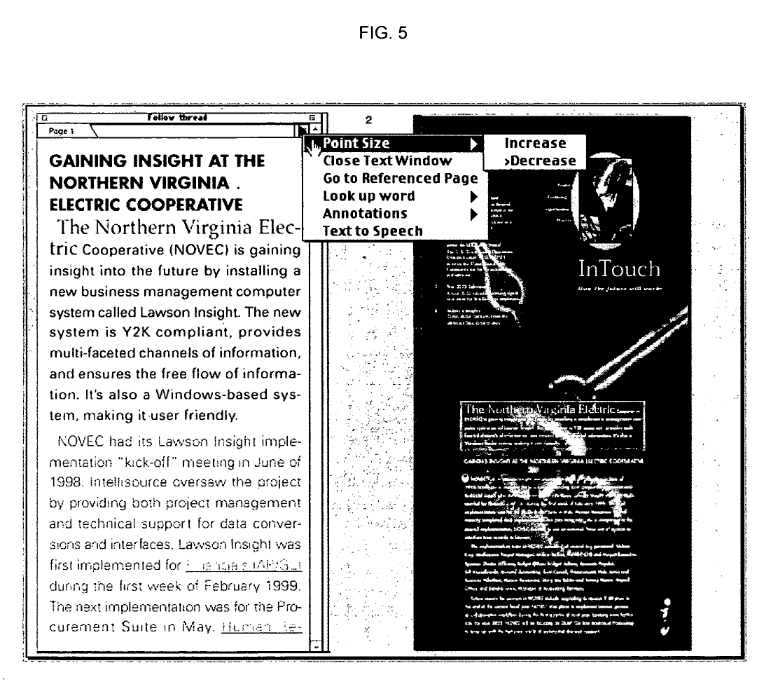

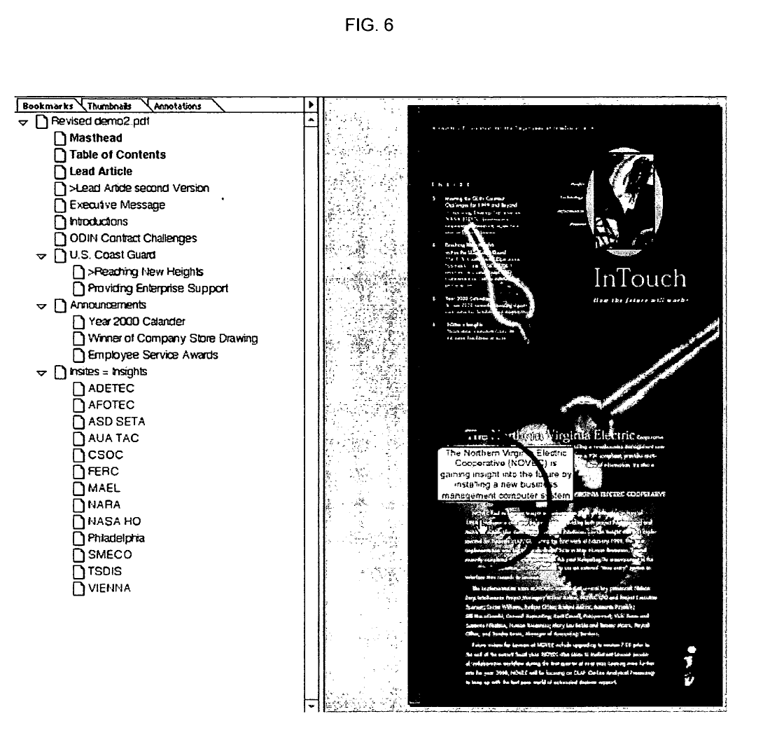

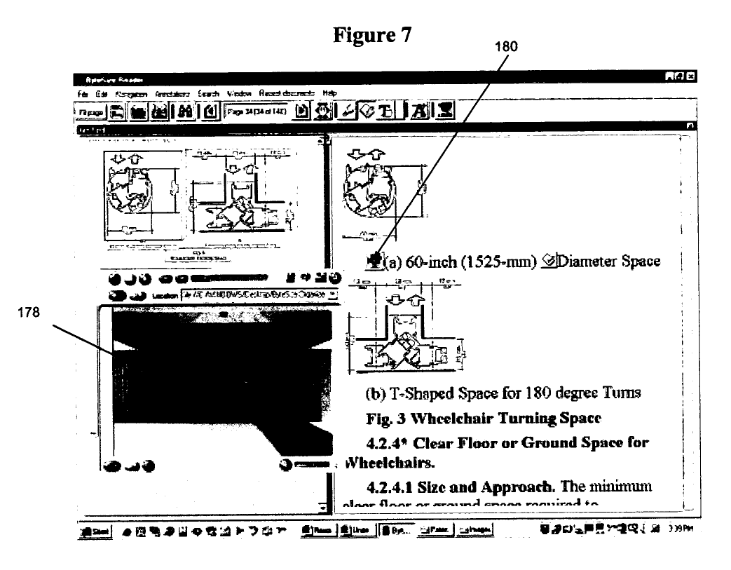

Referring back to FIG. 3, there is shown an icon 152 that represents a note. The EIW 182 may also include control buttons (not shown) that may be used to markup the text in the EIW 182. These control buttons and other controls in the EIW provide access to the tools 106. In FIG. 3, text 192 is highlighted using control buttons in the EIW 182. The EIW 182 may also include a control bar 186 that shows page numbers in the boxed portion 191 of the electronic page view 194. Also, the user may increase or decrease the font size of the text in the EIW 182. Shown in FIG. 5 is an example screen shot of the menu and submenus used to increase or decrease the font size of the text in the EIW 182. The text extraction for use in the EIW 102 may be initiated by bookmarks, which point to chapters, sections, headings, and other structural information in an electronic document. Shown in FIG. 6 is an example screen shot of Adobe™ Acrobat™ bookmarks for an associated PDF electronic document.

In addition to text, the electronic information displayed in EIW 182 may include icons and hypertext which represent pictures or images, graphs or other statistical information, URLs, file names and file paths for information on the Internet or a networked computer, sidebars, related sections, and other structured elements. The information may also include icons representing and providing access to audio or audiovisual clips. Activating these icons and hyperlinks will perform some action appropriate to their represented element. For example, FIG. 7 shows an embedded audiovisual clip 178 represented in the EIW 182 as film icon 180. When the user selects the film icon 180, for example, by clicking on the film icon 180, a sequence of steps is carried out. These include launching a movie player, which is capable of playing the audiovisual clip, executing a code sequence to perform commands relating to playing the audiovisual clip, opening a file containing the audiovisual clip, and playing the audiovisual clip. As is known in the art, selection of an icon on a graphical user interface may be performed by actions including passing a mouse over the icon and executing keystrokes selecting the icon. Further, the information represented in the EIW 102 may include music, audio compositions, visual clips, and other sensory information as may be developed in the future.

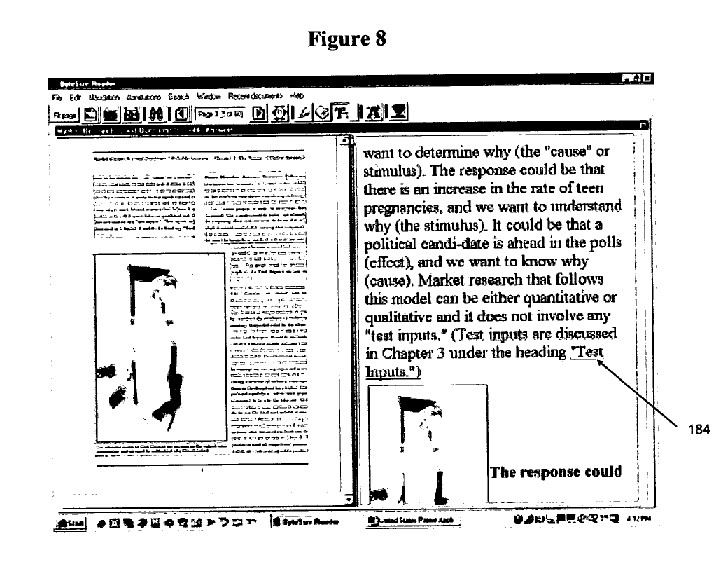

The EIW 102 also allows for inner and outer document links between pages or structural elements of the document. Varying properties, such as color, font, size, etc., associated with the text depicts linking to another document element or structural element. For example, shown in FIG. 8 is a link 184 to another page in or out of the electronic document from the displayed page. When the user selects the link 184, for example, by clicking on the link 184, a sequence of steps is carried out. These include launching a browser which displays the information associated with the link, changing the display of the electronic page view 100, marking the electronic page view 100 with the appropriate markup annotations representing the link, and executing code sequences to perform commands to display information relating to the link. Note that in this example, the link 184 was available in the EIW 102, but the link 184 may also be embedded in the electronic page view 100.

Clicking via a mouse or other selection device, anywhere in the display area of the EIW 102, advances the selection of free-flowing text viewed by the user. Advancing the free-flowing text may also change the view or advance the electronic page view 100 to conform to what is being displayed in the EIW 102. When the user advances the selection of free-flowing text, a sequence of steps may be carried out. These include extracting new text from the electronic page view 100, placing the extracted text in the same or additional EIW 102, placing the extracted text at the top of a new column, and executing code sequence steps that relate to advancing the free-flowing text.

B. Information Manager

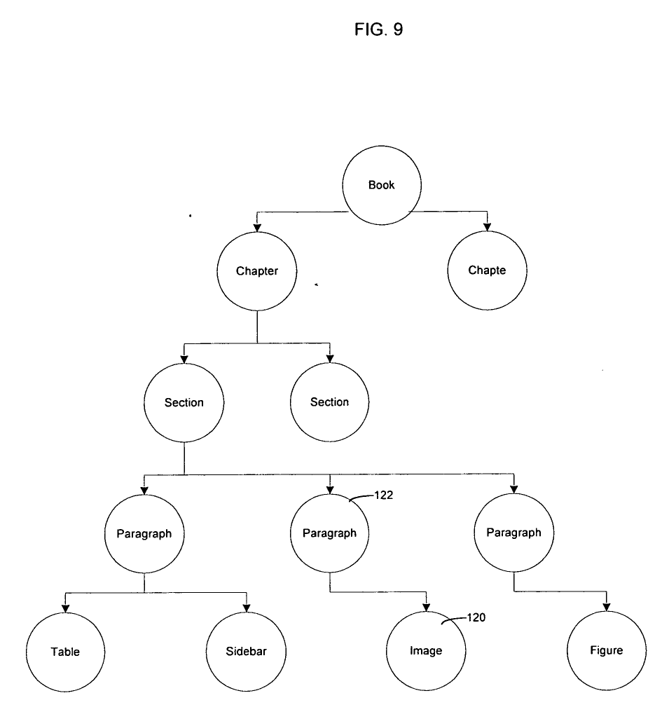

Among other functions, the Information Manager 104 functions to analyze, manage and send information from or between the electronic page view 100, the EIW 102, SmartNotes, the Citations Manager, the Icons Manager, the Acronyms Manager, or the Style Manager (described herein). As used herein, information includes markup annotations organized in a structure tree; text specifications, such as font, color and size, etc.; picture and multimedia resources; and page coordinate locations of these elements on the electronic page view 100. The Information Manager 104 serves the EIW 102 with extracted information to be viewed by the user. Information from the electronic document is saved in “markup data” and, thereby, the Information Manager 104 functions to manage markup data. Markup data includes markup annotations that delineate elements in the electronic document. The markup data also includes a structure tree that represents relationship information between structural elements in the electronic documents. Structural elements include a book, chapter, section, paragraph, table, figure, sidebar, image, audio, and visual files. In FIG. 9 a structure tree is shown which may be stored in the information manager. The structure tree may include the relationship that image 120 is a child element of paragraph 122.

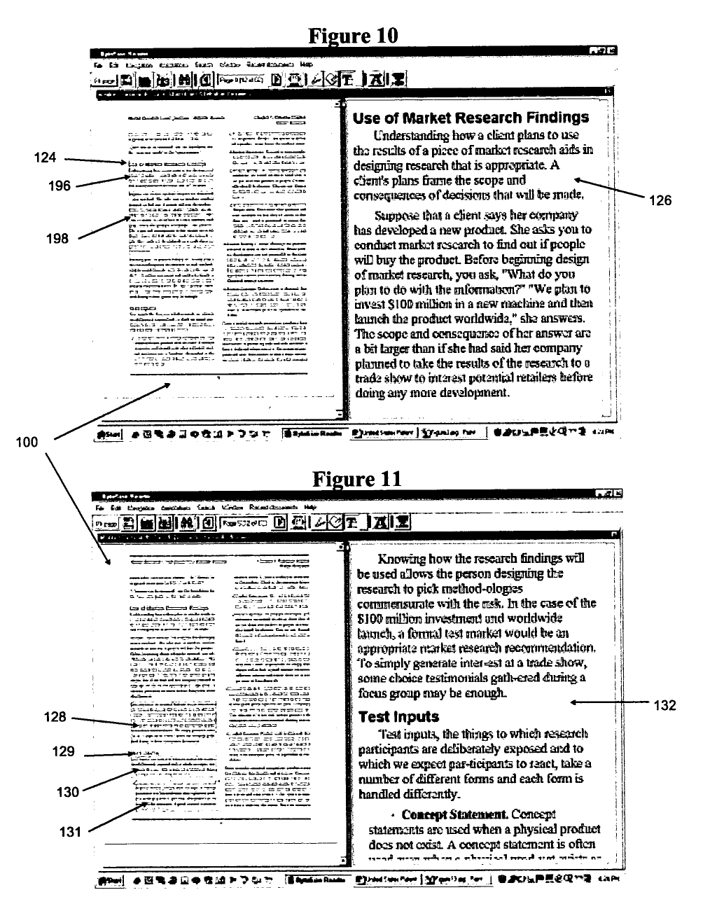

A markup author of the Information Manager 104 annotates portions of electronic page view 100 in the electronic document by adding markup annotations. Annotating is the process of defining coordinate parameters for portions of the electronic page view 100 in the electronic document and adding information related to the portion bounded by the coordinate parameters. For example, shown in FIG. 10 is an electronic document with markup annotations 124, 196, 198. Three boxes have been drawn around three paragraphs on the electronic page view 100. The information manager extracts the information shown in the bounded boxes and displays it in the right display area 126 of the screen 200.

The markup data also includes information linking the markup annotations 124, 196, 198 with the extracted information in the display area 126. This linking information includes the location of the text that was extracted from the markup annotations 124, 196, 198, and the relationship of the markup annotations to other elements. By storing a markup annotation with structural element relationship information, such as illustrated in FIG. 9, the markup author of the information manager 104 manages the flow of information in the EIW 102.

FIGS. 10 and 11 describe how the information manager works in practice. In FIG. 10, there is shown markup annotations 124, 196, 198 with the corresponding display area 126 and appropriate text information. The next markup annotations 128, 204 (shown in FIG. 11) contain paragraph elements that follow the paragraphs shown in annotations 124, 196, 198. When the computer user clicks (usually via mouse 110) on a markup annotation, the corresponding information is displayed in the left display area 126 of EIW 102. Further, when the user finishes comprehending the information in the display area 126, the user is given more information that follows the previously viewed information by clicking the mouse in display area 126 or by pressing a keyboard key, such as the Return key or Page down key. This new information flows as shown in the display area 132 and new markup annotations 128, 204 are highlighted in the electronic page view. By viewing the highlighted markup annotations on the electronic page view 100, the user is able to understand where on the electronic page view 100 he or she is reading. This embodiment of the EIW 102 preserves physical orientation features of a page without sacrificing readability of the textual information.

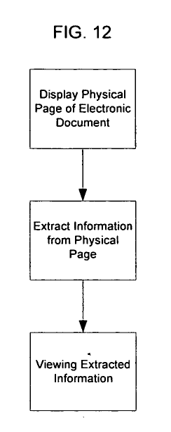

As shown in FIG. 12, a method for displaying and viewing electronic information includes the steps of (a) displaying in a first window an electronic page view from an electronic document where the electronic document includes representations of physical pages, (b) extracting information from the electronic page view, and (c) presenting the extracted information in a second window. The method may be used for uses such as electronic books manuals, contracts, reports, documents, and electronic course books. For example, a computer user may have an electronic copy of a C programming book. Being able to see the electronic page view 100 in one window and being able to read portions of the electronic page view 100 in a second window may facilitate reading and comprehending of the electronic text. Alternatively, a user of PDAs or other handheld computers may want to carry a mystery novel in electronic form on a long-distance airplane trip. Such a user may want to know how many pages he or she has read or how many pages are left before he or she is finished with the book. Being able to view physical characteristics of a book in one window and read text in another window can enhance the electronic reading experience.

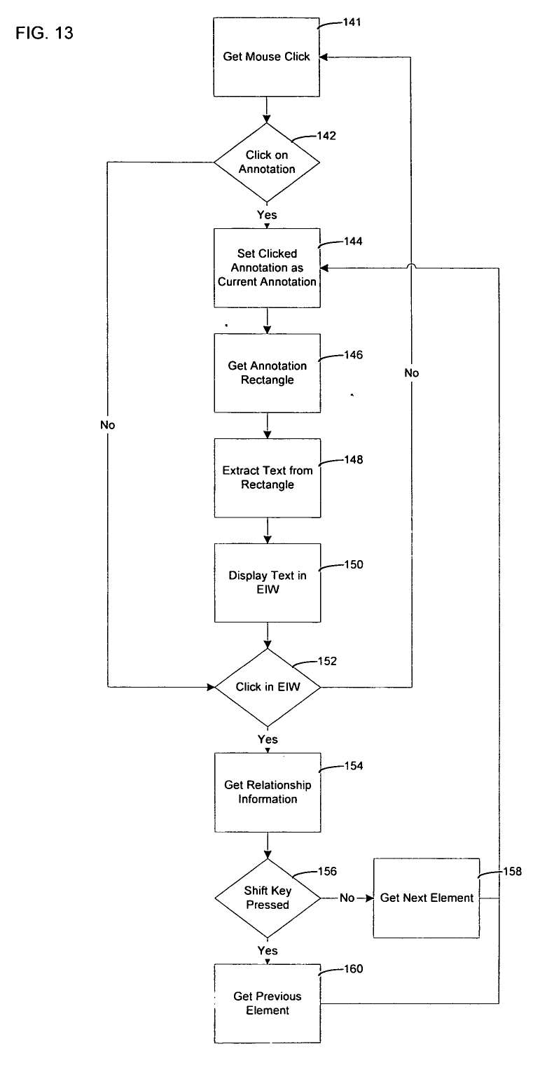

Specifically, as shown in FIG. 13, an embodiment of the method described above includes following markup annotations in a page description or document file format, such as PDF, to view an electronic page view, extract information from the electronic page view, and display the extracted information. In an embodiment of the invention, markup annotations may define textual, graphical or multimedia elements.

The step of displaying in a first window functions to present an electronic page view from a file in some page description or document file format, such as the PDF file format. A file may contain much electronic information representing many physical pages. The step of displaying an electronic page view may represent one physical page, multiple physical pages, or a portion thereof from the file and display the graphic image in a window. The computer user may click on the displayed markup annotation (Block 142 in FIG. 13) whereby the annotation clicked on will be set as the current annotation (Block 144). Further, a rectangle bounding the text may be obtained for the markup annotation clicked on (Block 146) and its text extracted (Block 148). For example, in FIG. 10 electronic page view 130 represents a physical page and graphic 124 represents a markup annotation with a box around it. Extracting information from the text on an electronic page view bounded by a markup annotation may also be triggered by other events, such as clicking a bookmark, activating a hyperlink, voice command, or some other trigger that points to the structure tree at an associate markup annotation. Activating these other triggers takes the place of Blocks 141 and 142 in FIG. 13, where the annotation itself is not clicked, but the annotation that is associated with the trigger is set as the current annotation in block 144.

The step of extracting information functions to convert electronic information in a page (Block 148) to electronic information that may be manipulated for use by the EIW (Block 150). For example, in FIG. 11, portions of three paragraphs from electronic page view 140 have been selected for extraction. This step retrieves the information encompassed by markup annotations 198, 128 and 204 from the three paragraphs and translates the graphic into textual information as in the display area 132. Specifically, this step further requires seeking tags representing paragraph information and copying the text from the paragraph elements and displaying the graphic image in a window. The computer user may click on the displayed markup annotation (Block 142 in FIG. 13) whereby the annotation clicked on will be set as the current annotation (Block 144). Further, a rectangle bounding the text may be obtained for the markup annotation clicked on (Block 146) and its text extracted (Block 148). For example, in FIG. 10 electronic page view 130 represents a physical page and graphic 124 represents a markup annotation with a box around it. Extracting information from the text on an electronic page view bounded by a markup annotation may also be triggered by other events, such as clicking a bookmark, activating a hyperlink, voice command, or some other trigger that points to the structure tree at an associate markup annotation. Activating these other triggers takes the place of Blocks 141 and 142 in FIG. 13, where the annotation itself is not clicked, but the annotation that is associated with the trigger is set as the current annotation in block 144.

The step of extracting information functions to convert electronic information in a page (Block 148) to electronic information that may be manipulated for use by the EIW (Block 150). For example, in FIG. 11, portions of three paragraphs from electronic page view 140 have been selected for extraction. This step retrieves the information encompassed by markup annotations 198, 128 and 204 from the three paragraphs and translates the graphic into textual information as in the display area 132. Specifically, this step further requires seeking tags representing paragraph information and copying the text from the paragraph elements.

The step of presenting the extracted information functions to give a computer user the ability to easily read the electronic information. As shown in FIG. 10, free flowing textual information is viewed in display area 126. Further, the user may easily comprehend the information in the electronic document by navigating the electronic page views by manipulating the display area 126. Specifically as shown in FIG. 10, the user may use the mouse to click in the display area 126 of the EIW 102 to advance in the structure tree to get further information (Blocks 152-160 in FIG. 13). For example, in FIG. 10, the user may click in column 126 to continue reading the text shown on the page (130 or 140) in FIGS. 10 and 11. As shown in FIGS. 10 and 11, clicking in the display area 126 of the EIW 102 advances the text and displays further information as in the display area 132.

Note the use of a mouse click is not meant to be limiting, but is by way of example. The computer user may use a variety of means to display, view and advance electronic information. These include a touchpad, stylus touch screen, a scroll wheel or button on a mouse like device such as a trackball, pen with a computer pad device, an eye motion sensor, an electromuscular current detector, keystroke, a combination of keys, and voice activated commands such as “more,” “next page,” “previous,” and “last page.”

The method may be carried out by general-purpose computer systems, and/or specialized digital (or analog) logic systems. As an example of a programmed general-purpose computer system implementation, the following program may use a programmed general-purpose computer system, such as that based on an Intel PIII™ microprocessor based system. In this regard, the following C program implements a portion of the electronic information management system and illustrates the method for displaying and viewing electronic information of FIG. 12. C function “BSBReaderDoClick” extracts text from a part of a page bounded by an annotation and displays the text in the EIW 102, as shown in Blocks 142-150 of FIG. 13. C function “DisplayWindowMouseDown” finds annotations following from the ones currently displayed, extracts text from the part of the page bounded by the annotations, and displays the text in the EIW 102, as shown in Blocks 152-160 of FIG. 13. Further, in this embodiment, the C program makes use of the Adobe Acrobat Application Program Interface (API) to manipulate the PDF file and uses Tcl/Tk for displaying information in EIW 102.

1 /* This function is called when the user clicks on a
markup annotatation. This extracts text from the part of
the page bounded by the annotation and displays the text
in the EIW. */
static ACCB1 ASBool ACCB2 BSBReaderDoClick(AVTool tool,
AVPageView
pageView, ASInt16 xHit, ASM16 yHit, ASInt16 flags, ASInt16
clickNo)
{ PDAnnot foundAnnot; if (!AvPageViewIsAnnotAtPoint
(pageView, xHit, yHit, &foundAnnot)) return false;
// We're on an annot. Is it a markup annot? if
(PDAnnotGetSubtype (foundAnnot) !=
BSBMarkup_K) return false;
currentPageview = pageView;
currentAvDoc = AVPageViewGetAvDoc (currentPageView);
currentPDDoc = AVDocGetPDDoc (currentAvDoc);
if (displayWindowLocation = = dispWinSide)
AVDocSetViewMode) currentAVDoc, PDUseBookmarks);
//display bookmark pane
// Create word finder if it doesn't already exist for the
PDDoc.
if(!wordFinder)
{ DURING wordFinder = PDDocCreatewordFinder)currentPDDoc,
NULL, NULL, NULL, 0, WXE_XY_SORT, NULL);
HANDLER
char errorBuf [256];
AVAlertNote (“Error in creating word finder”);
AvAlertNote)ASGetErrorString (ASGetExceptionErrorCode( ),
errorBuf, 256));
END_HANDLER }
KeepAnnot = DisplayNextBlock(foundAnnot);
return true;
} //BSBReaderDoClick
/* This function is called when the user clicks the mouse
in the EIW. */
This code finds the next annotations after the ones
currently displayed, extracts text from the part of the
page bounded by the annotations and displays the text
in the EIW. */
int DisplayWindowMouseDown)ClientData clientData,
Tcl_Interp *interp, int argc, char
(argv[ ])
{
float first, last;
PDAnnot prevAnnot;
_ElementPart elementPart;
// Scroll screen. If shift key pressed, scroll up.
if (AvSysGetModifiers( ) & AV_SHIFT)
// Scroll up one screen. If at top, move to previous
rectangle.
// Shift key pressed.
// Have we already scrolled up all the way to the top?
{ char command2[ ] = “.textWindow yview”;
retcode = Tol_Eval(tclInterp, command2);
sscanf(tclInterp−>result, “%f%f”, &first, &last);
// If at top, move to previous text block.
if (first = = 0.0)
{
// Go back to beginning of previous text block.
prevAnnot = firstAnnotinWindow;
for (ASInt32 i = 1; i <= NUMBERPARAGRAPHSPERBLOCK;
i++)
{
// Go back to start of whole element.
do
{
prevAnnot = MUAnnotGetPrev(prevAnnot);
elementPart = MUAnnotGetElementPart (prevAnnot);
}
while ((elementPart != wholeElementPart) && (elementPart !=
beginElementPart));
}
nextAnnot = DisplayNextBlock(prevAnnot);
char command2[ ] = “.textWindow yview scroll 100 pages”;
//scroll to bottom
retcode = Tcl_Eval)tclInterp, command2);
}
else //
Scroll up one screen.
{
char command1[ ] = “.textWindow yview scroll -1 pages”;
retcode = Tcl_Eval(tclInterp, command1);
}
}
else
// Shift key not pressed.
{
// Have we already scrolled down all the way to the bottom?
char command2[ ] = “.textwindow yview”;
retcode = Tcl_Eval(tclInterp, command2);
sscanf(tclInterp−>result, “%f%f”, &first, &last);
// If at end, move to next text block.
if (last = = 1.0)
nextAnnot = DisplayNextBlock(nextAnnot);
else
// Scroll down one screen.
{
char command[ ] = “.textWindow yview scroll 1 pages”;
retcode = Tcl_Eval(tclInterp, command1);
}
}
tclInterp−>result = “”;
return TCL_OK;
} //DisplayWindowMouseDowm

The present invention may be embodied in the form of computer-implemented processes and apparatuses for practicing those processes. The present invention can also be embodied in the form of computer program code embodied in tangible media, such as floppy diskettes, CD-ROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

C. Tools

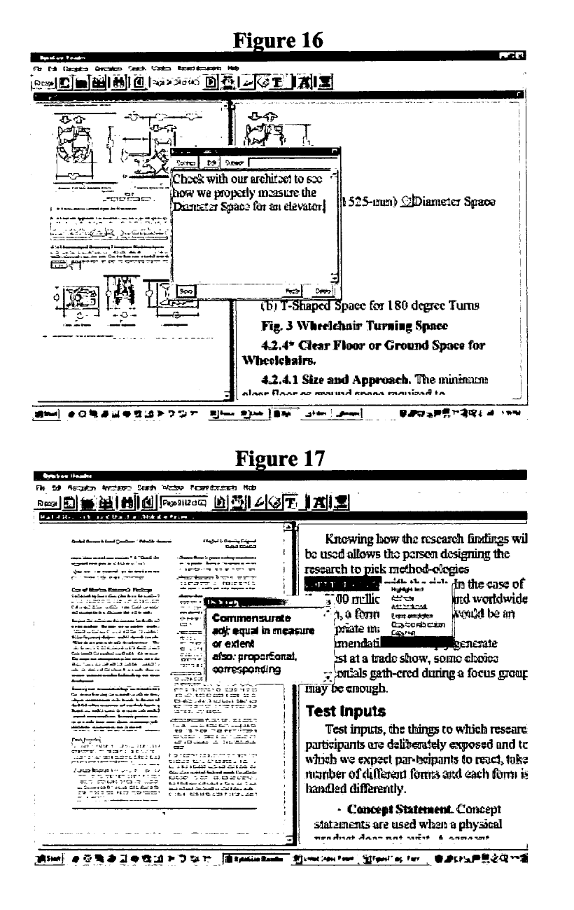

An embodiment of the present invention allows the user to add notes to an electronic document. As a user is reading an electronic text as shown in FIG. 16, the user may want to remark that the information requires further research. Shown in FIG. 16 is an example of a note added to a document. The text is highlighted to visually call attention to the reader and may have further information available in the form of a note. Further, clicking the mouse or otherwise selecting the text that is associated with the note displays the note to the user. Notes can be in the form of typed text, handwritten notes with a stylus, or a combination of the two using handwriting recognition functions. Other user created annotations may also append files in the form of word processing files, encapsulated postscript files and PDF files. Still other user created annotations may be a bookmark tool to tag spots in the EIW 102, voice recordings and voice to text recognition, a notepad with word processing capabilities, or a tool to add user defined hyperlinks within the EIW to other structural elements.

For purposes of this disclosure, “notes” include but are not limited to all of the following: highlights, notes, bookmarks, links, expert annotations, and search results.

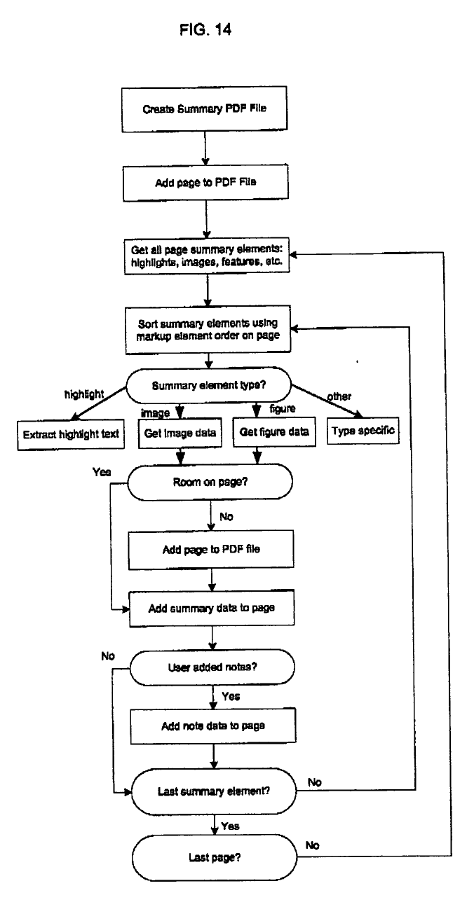

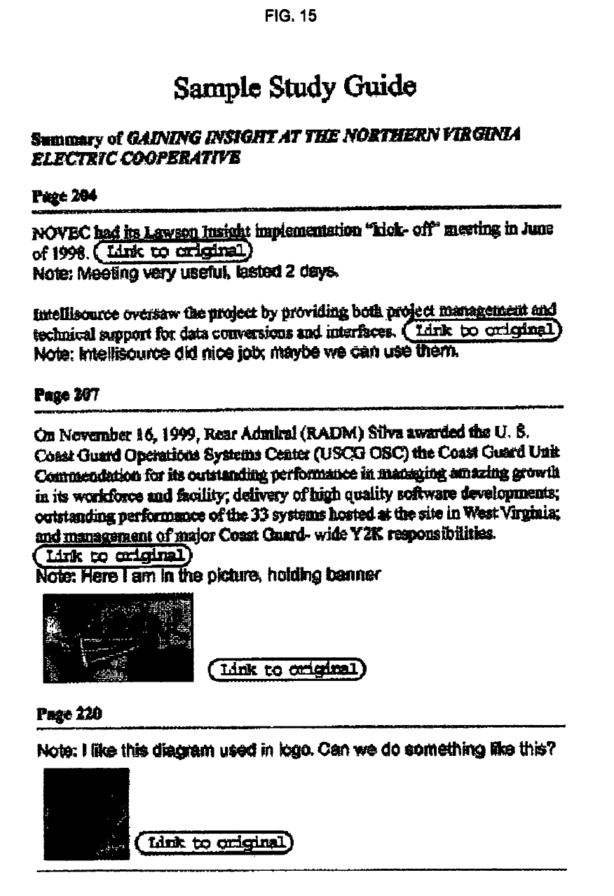

From the notes added to the electronic document, the user can create a personal study guide from the information shown in EIW 102. FIG. 14 shows a flow diagram for creating a study guide. The user is able to create a study guide that includes electronic information from the EIW 102 including text, images, and figures. An example study guide is shown in FIG. 15.

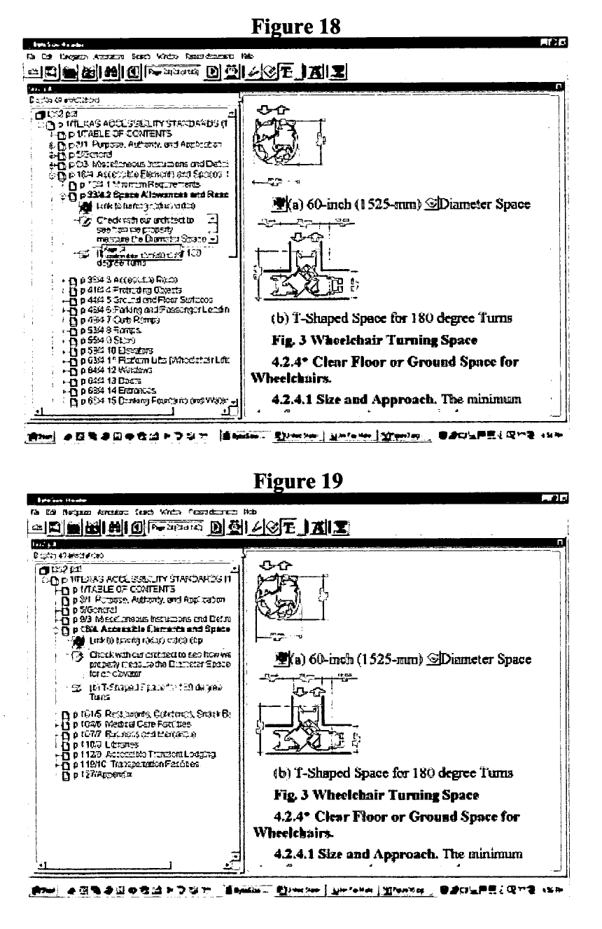

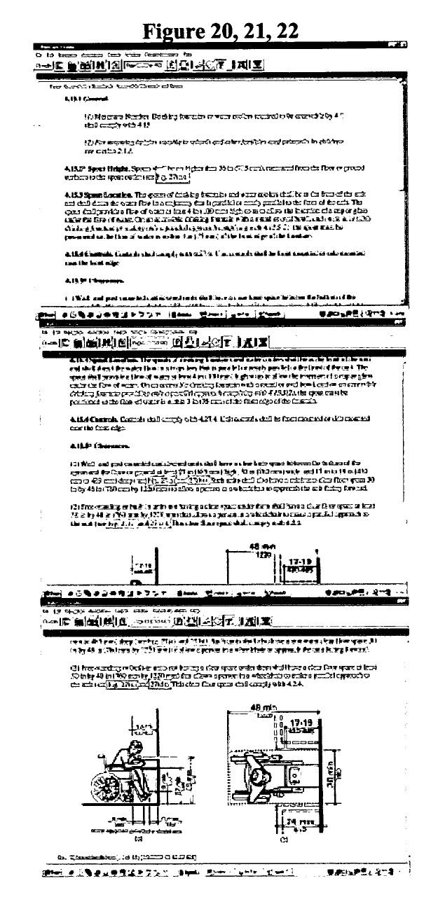

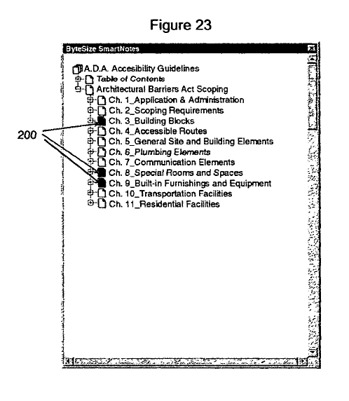

An embodiment of the present invention allows the user to look-up unfamiliar words in a dictionary. For example, the user may be unfamiliar with the word “meritorious”. Clicking on the word and selecting a dictionary may display a definition for the word. In another embodiment, clicking on the word also presents a pronunciation of the word. Shown in FIG. 17 is a screen shot of how this tool works. The dictionary used may be a built-in dictionary, local files on the user's computer, or an Internet-based dictionary. Further, the user may specify to retrieve a definition of an unfamiliar word using a search engine on the Internet. For example, computer terms that may not be in the built in dictionary may be found on a specialized database for technical terms, such as Webopedia by Internet.com. An embodiment of the present invention may allow the user to select the location where a definition may be retrieved. Further, if after retrieving a definition for an unfamiliar term, the computer user may be prompted to learn more information by listening to a lecture or viewing class notes relating to the unfamiliar term. The computer user can also insert an annotation that links the text to a definition stored elsewhere.

An embodiment of the present invention allows the user to look up unfamiliar words in an encyclopedia. For example, the user may be unfamiliar with the term “appendectomy.”Clicking on the word and selecting an encyclopedia may display the required information to understand the term. The encyclopedia used may be a built-in encyclopedia, local encyclopedia on the user's computer, or an Internet-based encyclopedia. Further, the user may wish to retrieve a lecture or view an appendectomy surgery by connecting with a remote computer, such as via the Internet. An embodiment of the present invention may allow the user to select the location where information may be sought.

### III. Synchronization, Compatibility, and Enhancements

An illustrative embodiment of the system incorporates extensive synchronization features, wherein synchronization is defined as sharing information between more than one computer. For example, one embodiment of the system resides on a desktop computer. With such an embodiment of the system, the user is able to synchronize information between the desktop and a third party information management system residing on a PDA, other handheld computer, or a laptop computer. In such an embodiment, the computer user may synchronize an electronic document on the desktop with one on a PDA or a laptop computer. Alternative embodiments may reside completely on their own in a PDA or a laptop computer.

An exemplary embodiment of the system may also provide World Wide Web services. In such an embodiment, the system consists of an off site Web server to which users can upload electronic documents. Such a Web server further may offer global access to electronic documents that do not exist on the computer user's local computer system. Users can then access, organize, and navigate a Web representation of the uploaded information. Furthermore, such an embodiment would provide synchronization services between the Web server and the computer user's local computer system. The Web server may also provide sharing services to enable a second user to access the computer user's electronic documents in accordance with the first user's permission. For example, a computer user named Mark may want to share his electronic copy of XYZ book with computer users Carole and Scott. Mark may set a time limit for when users Carole and Scott may access his book and for how long they may keep the book. Thus, the Web server may serve as a manager of “loaned” or “leased” electronic documents.

### IV. Portability

The present invention is portable via diskettes, portable hard drives, solid state memory devices, e-mail, LAN/WAN connection or over the Internet via upload and download to any computer. In an exemplary embodiment, the computer user's electronic documents may be transferred to another computer. For example, this enables the user to carry his electronic books from one computer to any other computer.

The present invention can also be installed on a network server. This would allow the user to maintain the electronic documents he or she moves from one workstation to another. In a preferred embodiment, the user's electronic documents are made secure via a password.

Portability will now be explained by way of example. Suppose computer user, Gary, decides to travel for a brief work assignment. Gary creates a series of diskettes that will contain an electronic document. Alternatively, Gary could transfer his electronic document to a web site so that he could then transfer the electronic document into his computer at the other office as soon as he arrives there. Further, Gary may want to carry his electronic document with him as he travels and he may want to download it to his PDA.

### V. Advanced Features

In an alternative embodiment, an embodiment of the present invention may employ algorithms that can analyze a query styled in natural language and be able to respond to that query. Natural language is defined as a way of wording something that emulates how we speak. Algorithms can account for various languages with varying dialects. In this way, an end user is not required to memorize cryptic commands to get the software to answer simple queries. Queries can be input through various means, such as keyboard and the spoken word.

In an alternative embodiment, an embodiment of the present invention may employ filtering processes to present in the EIW things that are user defined as desirable, leaving out the remaining content. An example of this may be termed as a “skim mode”, where only the heads/subheads and the first lines of paragraphs are presented. Other variations include presenting pertinent information to a query made by the user or presenting information on related topics. The filtering process may work in several ways, graying out the unwanted text, highlighting the desired text or removing the unwanted text altogether from the display area of the EIW.

V.A.a. Personalizing Annotations and Viewing Preferences

When more than one person uses the same computer, or when users intend to collaborate by sharing annotations, it is important to identify and keep separate each person's annotations and personal viewing preferences.

Part of this invention is keeping different user's annotations separate by storing annotations in separate user-defined files or combinations of files and folders. In addition, part of this invention is a way for different users to store their viewing and use preferences separately to retain customization on a user level.

V.A. SmartNotes

The SmartNotes window serves three primary purposes: a) navigation, b) annotation study, and c) display of search results.

Navigation. SmartNotes recognizes all of the hierarchical headings in a document (chapters, sections, headings, subheadings, sub-subheadings) and displays them in the SmartNotes window. Double-clicking on any hierarchical heading in the SmartNotes window jumps both the PDF page view and the EIW window to that place in the document. The SmartNotes window is like having a live and very detailed table of contents open and active all the time. To aid navigation and to help users know where they are in a document, SmartNotes can highlight the specific hierarchical headings that are currently displayed in the PDF page view and the EIW windows. The reader will appreciate that there are numerous ways to highlight specific items including but not limited to bold, underline, color, font size, and special icons. SmartNotes can display either the single heading that is at the top of a page or selection of content, or it can display all of the headings that are displayed.

Annotation Study. Annotations can be created directly within SmartNotes or they can be made in the EIW. In either case, annotations, at the user's choice, may be displayed between the hierarchical headings in the SmartNotes window so that the annotations are displayed in context. Because people want the choice of studying either on the computer or on paper, a variety of summaries can be printed from the SmartNotes window. The advantage of this simple concept is best appreciated through examples:

Example: A college student has read 100 pages of an economics textbook and added extensive personal annotations to the text—highlights, notes and bookmarks with explanatory notes. The student has done a thorough job and knows that, when it comes time to study for the test, she will only need to review her annotations. The night before the test, using the software of this invention, she reviews for the test using only the SmartNotes window. What would have been 100 pages to review is collapsed to, say, 20 pages, and it can be printed to study sitting under a tree. As she reviews her notes in the SmartNotes window, she finds a note that does not jog her memory sufficiently—she needs to see the note in a larger context. She clicks on the note and the PDF page view and EIW windows jump to the place where she wrote the note, allowing her to see her note in context. SmartNotes is not a shortcut to learning; it just makes the process more efficient.

Example: A lawyer has subpoenaed thousands, or tens of thousands, of pages of documents from a drug company in a product liability case. The lawyer hired a service bureau to mark up the documents so they could be studied and annotated on computer rather than sitting in a room full of file boxes and a stack of yellow legal pads. The lawyer has gone through the documents and gleaned important bits of information from many in the form of highlights, notes, and bookmarks with explanatory notes. To build his case, the lawyer reviews his notes, highlights, and bookmarks using the SmartNotes window in the software of this invention. The lawyer sets the SmartNotes window to display only those documents that have his annotations, which reduces the number of documents displayed from thousands to a manageable few. Now, using the software of this invention, the text-capture tool, the lawyer copies and pastes from the documents and his annotations (with complete automatic citations using the Citations Manager described as part of this invention) into his word processing program to write his case strategy.

Example: An architect is designing a new building and needs to design walkways, restrooms, parking areas and entries so they are accessible to people with disabilities. Designing to meet the Federal guidelines for accessibility (ADAAG—Americans with Disabilities Act Accessibility Guidelines) is not new to the architect. She has purchased the ADAAG in the format of this invention and has made extensive annotations in the ADAAG as a result of previous design projects. She knows that she has already highlighted the specific sections of the ADAAG that she needs to review. Rather than look through the entire ADAAG, she uses the SmartNotes window to find the sections she wants and the highlights she has already made. Once she finds the exact standard that she wants, she copies and pastes it (with complete citation reference) into the project document she is creating in her word processing program that maintains a record of compliance.

V.B. Filtering Annotations and Content

SmartNotes, at the user's discretion, contains outline and header elements and annotations, but is not limited to this information. A particular advantage of SmartNotes is that it allows users to view and print summaries and condensations of content using a variety of filters and settings. Filters include but are not limited to type of annotation, specific annotation icons, annotation colors, annotation authors and groups of authors, creation dates of annotations, and page numbers of annotations. Settings include but are not limited to levels of document headings, headings selected by the user because they contain particular content, and selected documents or collections of documents. These filters can be used either to customize what is displayed on the computer screen or to customize what is printed to paper.

V.C. Search

The software of this invention may utilize a search engine. Search engines are well known to those skilled in the art. Part of this invention is a search engine that operates on content differently than other search engines. Typical search engines search all of the content between established boundaries. The search engine of this invention may have the capability of typical search engines, but also has the capability to search only selected structure elements in documents. For example, the search engine may be told to search only document headers, or particular levels of document headers, or only document titles, or only document meta-data (like creation dates or authors), or only annotations, or only selected types of annotations, or any combination of these things. The fact that the software of this invention identifies structural elements makes it possible to search only particular types of content within established boundaries.

Search results can be displayed in a number of ways which include but are not limited to displaying successive results each time a search is activated, highlighting all results of a search, listing all results of a search, and extracting all results of a search and displaying them in the SmartNotes window. Listing search results in a table is a particular part of this invention. Search results may be displayed in a list that contains several sortable information fields including but not limited to page number, element type if it is an annotation, header level if it is in a header, author if it is an annotation, and document source if it is in an expert annotation.

### VI. File Management and Annotation

A. SmartNotes File Storage

A computer file can be defined as an e-mail message, instant message thread, web page, PDF, word processing document, spreadsheet, database file, electronic facsimile, digital voice mail message, etc. Storage of computer files and their corresponding information are stored in a manner that is similar to when such thing were physical entities only, i.e. one file stored at one location with duplicates stored in other locations. This practice has carried over into the computer world where files are stored in electronic file folders and either moved or copied between them. Such approaches result in arbitrary and confusing organization of files, especially when these files cover broad topics that may be categorized in a number of ways. The first solution of storage is to store the file in the most obvious folder. This method is very subjective as people interpret documents in different contexts and thus creates potential retrieval problems. For example, in a network environment, a user is forced to wade through other people's organization schemes, resulting in frustration or missing documents. The second solution is to store duplicates in every category that may apply. This helps for basic retrieval, but creates version problems. If someone makes a change to a document that is stored in ten places, you are left with dealing with outdated files or redistributing the changed document back to the other nine locations. SmartNotes will store all files in one location and allow for a series of pointers to be stored in the program's organizer. In this way, a category location is a trait of a particular file rather than the file belonging to a certain category.

Moreover, there is no easy means for incorporating a system of granularity. Granularity means the ability to take a large document and access or divide it up into much smaller units. Examples of this may be a page from a PDF, a table from a Word Document or a highlighted sentence in a PDF. Currently, the file storage systems (MAC OS, Windows, Unix) do not deal with granular elements of files, leaving access to the granular components to the individual programs that created them. These granular items are micro units of files and are only viewed when the document it belongs to is being viewed. This symptom of hidden granularity does not allow for broader thinking of relating smaller sub-thoughts to the big picture. SmartNotes will allow equal access to larger documents and their granular components in the program's organizer. The only distinction between the macro and micro views will be with an iconic presentation to alert the user to the scope of the content (where the scope is defined as the range or extent covered). Whole documents have a larger scope than their granular components. Also, SmartNotes will store pointers to the granular items, rather than the granular content itself. For example, it will store a bookmark to a PDF page, rather than duplicating the PDF page and storing that. This will alleviate version problems and will not bloat storage media with redundant data.

The best way to clarify this approach is with an example: Jim e-mails Scott writing that Scott should review the attached document in time for a staff meeting on Friday. Additionally, the e-mail goes on to include some suggested changes that Scott should incorporate in the review process of the document. In current systems, Scott copies the attached document to a project folder and makes a task entry to review the document and a calendar entry for the staff meeting on Friday. He then moves the e-mail message to an Microsoft Outlook folder he has called “Hot Items.” This project, in a short amount of time, has spread out over four different programs and storage systems. What's worse is that by entering one system, for example the project folder, only gives Scott a narrow view of the whole. In the project folder, Scott is not able to access the due date or the suggested changes given by Jim. To access these, Scott must locate the other items in the other systems.

The SmartNotes approach is different in that it creates one point of organization through which the user can access all components. Scott would make one category that relates to the project that contains pointers to the attached file, the e-mail message, the task entry and the calendar entry. Each component is now viewed in context to the project. This does not replace the individual programs, but compliments them with a broader overview. So, if Scott wants to view his workload, he can still view his calendar and see the project in context with all the other things he has due on Friday.

A.1. Methods for Creating the SmartNotes Window

Because SmartNotes may be an extraction of information from one or several sources, the information (document headers and annotations) in SmartNotes may be created in a number of ways. A document can be scanned by the software to find all manner of headers and annotations, and this information can be used to create and build SmartNotes. Alternatively, the headers and annotations in a document can be saved to a separate file and this separate file can be used to create and build SmartNotes without having to open the associated document. Alternatively, the headers and annotations in a document can be extracted and stored as appended information to a document file and SmartNotes can be created and quickly built from this appended information without forcing the software to scan the entire document looking for headers and annotations. Alternatively, new and unique compilations of headers and/or annotations can be created by users and then stored as named files by users that can be reopened as SmartNotes.

SmartNotes has numerous advantages including that it can be created and built from collections of headers and annotations stored separately from their associated documents. Additionally, SmartNotes can display information from a multitude of documents at the same time with or without opening the associated documents. Another advantage is that users can recombine information in highly varied and unique ways that would be difficult to execute if SmartNotes were created by only scanning and compiling information within documents.

SmartNotes can be created from its source files to suit several purposes. It can be an outline of a larger document or collection of documents that aides in understanding and navigation through the document or documents. SmartNotes can be a way of combining parts of a variety of documents and then viewing those documents as outlines through their various headers and sub-headers. It can be a way of viewing annotations for one or several documents in context with the headers and sub-headers of the document or documents. SmartNotes can further be a way of combining and viewing annotations or groups of annotations from one or more documents in non-linear format. Non-linear format means that the annotations, with or without associated document header information, can be moved around and recombined in ways that suit the users' purpose.

An advantage of the SmartNotes concept is that information that is displayed on the computer screen, regardless of how it is moved around and recombined in non-linear format, retains its links to the underlying documents and annotations so that “clicking” on anything in SmartNotes immediately takes the user to the document and place within the document where the piece of content is shown in context.

While SmartNotes is often an extraction of content and annotations from one or more documents, it is not limited to being an extraction. In fact, when a user recombines information (document content and annotations) in non-linear format, the user is often able to realize, link and understand in ways that were not possible when the information was presented in linear format. Users naturally want to be able to record these new realizations and understandings and SmartNotes gives users a way to do that by allowing direct input of new notes. SmartNotes also makes it possible for users to copy-and-paste content at any level (multiple pages, pages, paragraphs, sentences, words, characters, figures, tables, graphs) to recombine it in new ways to create new understanding without losing the links to the original source of the information. An added feature of SmartNotes is that users can turn on or off at the click of a button the display of citations showing the original source of information.

A.2. Bookmarks created by SmartNotes

While bookmarks can be considered another form of personal annotation, they are different because of the expectations people have regarding bookmarks. People do not expect to be able to see highlights or notes without turning to the page in the book that contains the highlights. However, people expect to be able to see a series of bookmarks in a stack of books as they sit, unopened, on a bookshelf. Further, if the user knows that the bookmark of interest is blue, he can scan across a row of books for the blue bookmark without even knowing which book it is in. Bookmarks are like homing beacons that let a person who created them navigate exactly and directly to that spot. Further, if a person is told to go to a bookshelf and look for the bright blue bookmark, he can navigate not only to the book, but also to the correct passage in the book without knowing anything more than to look for the bright blue bookmark. Bookmarks can be very powerful navigation and memory tools.

The software of this invention allows users who are reading documents on computers to place bookmarks that guide them to exactly the place they want to go—the right book, the right page and the right place on the page. The software makes “smart bookmarks” that are color-coded and contain notes. These bookmarks guide users not only to the book and place, but also tell users what to find there.

The software of this invention scans a user's annotations in a single document or a collection of documents and pulls bookmarks into a list that can be in its own window or as a part of other windows such as SmartNotes. The list contains pertinent, sortable and searchable information about the bookmarks such as title of the document, accompanying notes, page number in the document, title of the bookmark, color, the name of the person who created the bookmark, the date the bookmark was created, and information linking this bookmark to other associated bookmarks. Clicking on a bookmark opens the document and displays it, beginning at or near the bookmark, in the EIW.

A-2. SmartNotes Annotation Storage

A portion of the present invention creates a Structure tree that is mapped to the document that acts as an electronic table of contents. The structure tree will hereafter be referred to as the Outline. The annotations may then be stored directly inside the Outline so that they have a framework for context.

A-3. SmartNotes Cell Approach

When the annotations are inserted into the Outline, they then achieve context. However, if the annotations are extremely long this can break up the Outline so much that it becomes very difficult to visualize the hierarchy of the structure. To alleviate this, the annotations are placed in a scrollable and resizable cell. In this way, there is a careful balance between seeing an overview of the structure and retaining the annotations in context.

A4. Annotations Positioned at Different Points in the Outline

For higher clarity and understanding, it may be necessary to view the Outline with varying levels of detail. For example, the document's Outline may be viewed with only the Chapter titles visible. Viewing the same document with more detail may show each Chapter title and one or more levels of subdivisions.

If you are seeking a broad overview, you may want to see your annotations inserted at the Chapter level. On the contrary, if you are looking for a detailed review, you may want to have your annotations inserted into each level so you can see exactly what subhead a particular annotation came from. The Outline may have multiple ways of expanding. In other words, the Outline's branches may be individually manipulated to either reveal the annotations using the current detail level or to expand the level of detail for the branch in question. This would then create a dynamic representation of the detail level, which is chosen by the user when they see fit.

For a practical example:

Outline with Broad detail

Ch 1

Annotation 1

Annotation 2

Ch2

Annotation 3

Annotation 4

Outline with Specific detail

Ch 1

Sec 1-1

Annotation 1

Sec 1-2

Annotation 2

Ch2

Sec 2-1

Annotation 3

Sec 2-2

Annotation 4

A-5. Distinguishing the Type of Annotation or “Tagging”

The invention may give the user the option to identify or tag the annotations as being a certain type. Types may include: questions asked, user specific comments such as “Gary's comments”, legal notes, formulas, etc. These type of annotations may be identified via specific icons or tags available to the user.

B. Accumulating and Binding Annotations of Granular Content

Bookmarks, notes and highlights based on granular content can be categorized into common themes. Those annotations are pointers to the disparate documents and not duplicates of the granular components. Bookmark pointers could be organized by the user into binder like structures and shared with others. Recipients of these bound annotations would have access to the network to have access to each granular component. If the Annotations binder was to be distributed to those outside the network, the granular components could be republished as a new document so all the components are available.

B.1. Scroll Bar Based on Logical Increments

Scroll bars in current software programs change what is displayed on the computer screen on a continuous basis. That is, they move the content up and down or across the screen at the smallest possible technical rather than logical increment. Examples of technical increments are a single pixel width, a single scan-line width, or a single line of text. Examples of logical increments are whole paragraphs, whole graphs or figures, whole pages, whole chapters or whole documents.

The software of this invention employs a user-configurable scroll bar that operates on the concept of logical rather than technical increments. Logical increments include but are not limited to whole paragraphs and whole figures, whole pages, whole outline or header levels, whole documents or whole collections of documents. The software of this invention adds structure to document files that may include logical hierarchy and logical breaks such as where paragraphs begin and end, where headers are, and what type of header it is. It is, therefore, a simple matter for the software to increment display according to one of these logical blocks.

While this particular invention is described as a “scroll bar” that operates on the concept of logical increments, the reader will appreciate that the concept of changing what is displayed according to logical increments can be done in a multitude of other ways. Some of those ways include but are not limited to using the arrow keys, clicking on “advance” or “retard” buttons, or any combination of key strokes, such as Control-down arrow.

The concept of incrementing display by logical elements can be applied to software and content outside that described by this invention. The method can be applied to any content that has logical elements that can be recognized by computer software. These logical elements can be either internal to the content such as paragraphs, sheets and page numbers; or it can be elements of meta-data that are attached to files, such as author and date.

C. A System to Retain User Profiles

One of the most difficult problems with search engines and the retrieval of documents is that it often returns documents that are not relevant to what the user is seeking. Any quick search with Google™ will result in wading though a list that numbers in the millions. For example, entering the keyword ‘Pyramid’ could return many contexts of this keyword, such as the Egyptian pyramids, the nutritional food pyramid, the mathematical area of a pyramid, or the belief by many that the pyramid shape holds healing powers. It may seem obvious that an archeologist would be more interested in Egyptian Pyramids. Then again, maybe he is a health conscious archeologist that digs up dinosaur bones. In this case he might want the nutritional food pyramid and not be interested in Egyptian Pyramids. Having an idea of what a user deems relevant, the search engine can direct the user more quickly to these documents.

In order to discern what a user may deem relevant, a method of evaluating a user's choices and creating a user profile would be helpful. Each action or choice a user makes is a hint at what that user finds important. Book marking a web page, highlighting a passage, storing a document or clicking a hyperlink are all potential data points to creating a user ‘relevancy’ profile. Currently, there is no system that monitors a user's choices on his/her personal computer to help guide the user to other items of interest. An example might be a person who prefers to view the newspaper on his/her personal computer. Most people have a pattern in which they prefer to read the paper. They might start with the front page, then move to the front page of the sports section, then move to the front page of the business section, then go back to the front page again. The computer records the viewing choices of the user. The computer may then display the next viewed newspaper in the previously viewed sequence. Alternatively, the computer may recognize patterns of viewing and prompt the reader to choose a viewing sequence for future newspaper viewings. These viewing sequences may include viewing all newspapers using a given viewing sequence or viewing the same newspaper using a first viewing sequence and a second newspaper using a second viewing sequence.

The first caveat to this approach is an issue of privacy. These profiles would normally be inaccessible to other users and be either encrypted or only readable to the software that interprets it. Also, privacy advocates would have problems if companies could tap into these profiles to gain competitive advantage, such as facilitating tailor made advertisements that fit a user profile. As a result, these profiles should remain on closed systems so they are like electronic assistants and do not become something to exploit. There may, however, be situations where a public or limited access profile would be desirable and useful.

D. SmartNotes Usage of a ‘Relevancy’ Profile

SmartNotes may have a filtering method that filters out items a user deems irrelevant. The SmartNotes program would have a login system that makes it aware of the user and can tailor its presentation to that user's relevancy profile. In a network environment of a large company, there will be a wide variety of documents from R&D to accounting. All files should be organized and retrievable, but the relevancy filter would only show the items or push items to the top, based on what the user deems relevant. This can be expanded to a granular level of revealing auto-generated bookmarks that point to certain passages of documents that match a user's relevancy profile. A Relevancy Profile may include tools for people with dyslexia. Once the dyslexic person was ready to read, he/she might use this invention to only display one reading line at a time so that he/she would not be distracted by other lines of text, graphs, or pictures.

E. Skim Feature Usage of a ‘Relevancy’ Profile

The skim feature in the EIW can be aware of the user ‘relevancy’ profile. When the skim feature is engaged, only the passages in the document that match the relevancy profile would show in the EIW. This allows the user to quickly get at content he/she deems relevant. To review the document in its entirety is as easy as disengaging the Skim Feature.

E.1. Literal Capture Feature

A particular problem with reading conventional PDF documents is that, when the document is scaled on the screen to see an entire page, the text is usually too tiny to read; and when the text is scaled on the screen so it can be read, the page flows off the screen which forces the user to scroll back and forth and up and down, to read it. Many people find this experience frustrating to the point that they print the document and read it from paper instead of trying to read on-screen.

While one of the objects of this invention is to add structure information to a PDF so that it can be read in the EIW and so that annotations can be added and outline levels can be extracted to a SmartNotes window, this invention also describes a way to read conventional PDFs that lack this additional structure information using both the full-page PDF viewing window and the EIW.

The Literal Capture feature of the invention displays conventional PDFs in full-page view in the PDF viewing window, which allows the user to see an entire page or pages at a time, but the text is probably too tiny to read. The software of this invention also allows the user to draw a box around a selection of text in the PDF viewing window and then extract this information as either a graphic or as text that reflows into the EIW window. This effectively adds either temporary or retained structure to the conventional PDF and allows the user to see both the entire PDF page or pages and specific extracted content in a size that is readable.

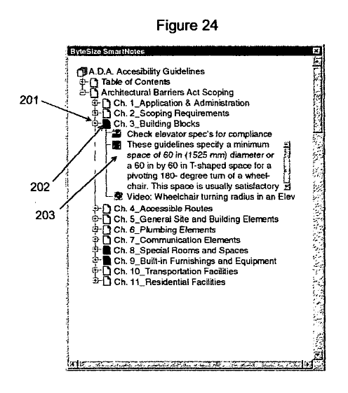

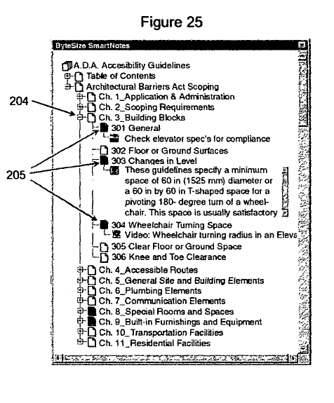

Another means of implementing Literal Capture with conventional PDFs is to display the full page or pages in the PDF viewing window, and to divide the page into sections that can be displayed in the EIW. Moving from section to section can be done by pressing the up or down arrow keys or by a number of other key or mouse steps that anyone skilled in the art can implement. The user can select the way to create sections based on the format of the document or based on personal reading style. For example, if the page is formatted with a single column, the user may choose to have Literal Capture display the page in three sections from top to bottom as is displayed in FIGS. 20, 21 and 22.

Another feature of Literal Capture is that it allows users to add outline and header structure to conventional PDFs. When a user identifies and marks an outline or header element, this structure information may be retained either within the document file or external to the document in a separate file. Once identified and marked, these structure elements can be added to the SmartNotes window which further allows the user to use these structure elements for navigation through a document and as a way to display annotations in context.

E.2. Adding Annotations to Conventional PDF documents

A particular advantage of a part of the invention described herein is that it describes a method of storing annotations in a file that is separate from the document file. The advantage is two fold: a) when the document is very long and is being used for collaboration by several people, a file that stores annotations separately from the document file is more portable than a long document; b) the document file is left unchanged and uncorrupted when annotations are added because the annotations are stored separately.

To store annotations in a separate file requires that each individual annotation contains several types of information: a) the content of the annotation, b) the location (one method to determine location is by referencing the page number in the document and the word offset on the page), c) the type of annotation (examples include but are not limited to color and icon).

E.3. Threaded Notes

The process of collaboration employs a series of questions, answers, comments, reactions, additions, changes and subtractions between two or more people. Part of this invention includes a collaboration method. When a note is created, the software of this invention places the note in the document at exactly the place chosen by the user, makes it possible for the author of the note to include his or her name as part of the note (either embedded in the note or attached to the note as meta-data), and allows the author to insert a signal such as an icon and a color to indicate the kind of action or response requested. When a collaboration partner sees the note, he or she can immediately see who wrote the note in context with the document and the kind of action or response requested. Clicking on a reply button that can be worded in any number of ways, the collaboration partner can reply to the note either by adding thoughts or answers directly to the note or by linking a new note to a previous note. When a note becomes a thread of several collaboration notes, the software enables several types of changes that signal the collaboration. Those signals include but are not limited to changing or adding icons, changing or adding colors, and changing or adding tool-tip pop-up data.

F. Method for Reading Documents that are Based on Pages (i.e. do not reflow)

Currently, users who read a page on a computer screen typically do so by scrolling a few lines at a time. Using page down methods are sufficient for browsing but are not very well suited for reading. This is because the page down method does not place new text at the top of the screen in a predictable fashion. This leaves the user to hunt on the screen for where they left off. This can be very distracting and leads to frustration. Out of frustration, users either print the document or resort to feeding the page a few lines at a time so that they can visually track where they are. The latter results in eye fatigue and goes contrary to effective reading habits of reading sentences in context to the related blocks of text.

An alternative would be to break the page into three horizontal zones. Each zone may be highlighted in turn, starting with the top and moving down the page. All areas outside the zone may be lightly grayed out but the text would still be clearly legible. In this way the user may venture out of the zone and easily read the cut through line without having to tweak the placement of the zone. Grabbing, resizing or repositioning the zone may get tedious if it needed to be done often. Also, by seeing the surrounding area you may increase your spatial awareness to the surrounding area. Taken a step further, the page may be divided considerably more than three zones and may adhere to the line structure. For example, you may have a highlighted zone that highlights three lines of text at a time and grays the rest of the page. This zone would move down the page three lines at a time. It is important to note that the zone moves, but the page stays still on the computer screen. Only when a zone moves off the boundary of the computer screen would the page view move. When the page view moves, the new zone to be read will always start predictably at the top of the computer screen.

G. Document Structuring the Way People Think

The markup and structuring of documents is a painstaking and cost prohibitive process. Most people's method of working is by typing memos, e-mails and reports in a free fashion with text editors and word processors. This is mostly done and styled for the viewing benefit of people's eyes and not much forethought is given to how this document may be more effectively used if marked up using XML. The end result is that many documents are structured after the fact or not at all, because it is cost prohibitive. SmartNotes provides the ability to integrate the markup process with the way people think. When this is done, users will be marking up content without even knowing just by working the way they would normally work.

The trick is to create SmartNotes in such a way that it becomes a pre-writitng and thought-organizing tool. A user will insert raw thoughts and pull prior notes and highlights from the knowledge database and use categories to organize those individual thoughts into concepts. The grouping and categorization serves as the structure of content that is normally thought of when content is marked up. For a practical example, a resume from a John Doe may be received for review. There may also be several e-mail correspondences from Mr. Doe. In the review process, a new category may be created called “John Doe” and put it under a Contacts category. Several unique facts have been collected while corresponding with John such as he went to University of Wisconsin (which are highlight and tagged as Education). He also has some interesting stories about hiking and running (which are highlighted and tagged as hobbies). During a phone conversation, John mentions that he likes climbing so a free note (meaning not pointing to a specific document) is created and added to the hobbies category as well. These sets of highlights and free ranging notes are stored under the John Doe category and make up characteristics of who John Doe is. These tags are extensible and make up the structuring process one would think of when using XML. Now some years later contact is made with someone who is interested in going to the University of Wisconsin. Performing a search on the tag “Education” results in over a hundred hits to various people. One hit takes me to the entry stored under the John Doe category. The information retrieved suggest that the new contact may contact John Doe to tell him all about the University. Further review of the John Doe category reminds me that he may be a good source for hiking trails and the like.

Once categorized and tagged, the user can then port that information to a report-building tool, which is basically a word processor that is synced up with the SmartNotes. Any changes or additions to the report can reflect the changes in the SmartNotes. Any changes or additions to the report can reflect the changes in the SmartNotes and vice versa. In this way people can organize thoughts in SmartNotes, rather than on paper, and then write as they normally would. The by-product is marked up content, with no prior knowledge from the user of how to do such a thing.

H. Structural Annotations

In the above example, each annotation may be identified by a tag from an extensible library of tags. This is more for future searching and edification, however there are other uses for tagging. These tags may have more structural significance and thereby affect how the content is actually presented and read. For example, a line of text may be highlighted and then tagged as “emphasis”. When this text is read though a Smart Screen Reader (such as provided for the blind) it would know how to interpret this new tag and provide extra emphasis in the Screen Reader's voice. This is important, because a publisher could be free to create their own base content and then special interest groups can review the base content and add to it specialized structural annotations that would assist the members of their group. The burden of markup for these special needs shift from the publisher to the special needs advocates. These annotations would ship with the base content and change the way the base content behaves.

I. Method for Comparing Similar Material in Two Different Documents

Architects must design to comply with both Federal and State standards. When the Federal and State standards are not precisely the same, architects have to compare the two different standards and then design to the stricter standard. A portion of this invention describes a system to put a full-page PDF on one side of the screen and then extract and reflow the content of the PDF into a comfortable reading window on the other side of the screen. To compare two different standards, a portion of this invention can provide the means to split the screen again, top to bottom, so that it shows four quadrants. One standard could be shown in the top two windows and the other standard in the bottom two windows.

Numerous methods can be used to synchronize the content in the top and bottom windows so that the comparisons can be made. One method is to let the user manually slide through content on the top and then the bottom so that each half shows what is to be compared. Another method is to use search techniques that rely on finding similar text strings and then synchronizing the windows upon finding similar text strings. Neither of these methods will provide quick and easy synchronization with satisfactory results. Another portion of this invention is to synchronize the content between the two files based on searching defined structure elements. When a document is marked up so that it can be interpreted by the EIW, it defines structure elements in the document. By concentrating a search to words only in structure elements, content can be synchronized quickly, easily and satisfactorily.

J. Skim Feature to Facilitate Reading and Studying.

As described herein, a portion of this invention allows contents to be extracted from a file, such as a PDF, and reflow the content into an EIW. The extraction process may take place under a set of filters to facilitate the reading and studying experience. This is called the “skim feature.” The skim feature may be set to extract only the first sentence in a paragraph, only the first and last sentences of a paragraph, only sentencing containing certain user-selected words in each paragraph, only sentences with “bolded” or italicized” words in each paragraph, only paragraphs that contain an annotation, only paragraphs that match the user's relevancy file, only paragraphs that contain certain elements such as a figure reference, etc. More over any combination may be chosen from the above. For example, extract first sentences and paragraphs that contain annotations. The skim feature reduces the amount of content to read. This technology entails analyzing a file for structure based on similar format. For example, a file may be formatted such that the book title is in 20-point type, chapters are in 18-point type, sections are in 14-point type, and paragraphs are in 12-point type. The invention recognizes the type size and puts similar type size on the same level in the structure tree. Additionally, the invention allows for user input to define the structure tree, as well as provide for correction if mistakes are made.

The invention uses this structure tree to provide the user with a personalized formatted “paper.” The user is able to input a desired format in which the structure tree can be displayed. For example, the user may choose to have all chapter titles in bold 15-point type in a specific font, and section titles in 13-point italic type. In this way the user becomes much more efficient. When looking at a new file, instead of taking the time to learn the style the author created the file in, the invention provides the file to the user in the format the user has already learned. In this way, reading become faster and easier. This style manager can extend to all levels of the structure tree, from the title of the book, to the size and font of the letters of a sentence.

K. Search Tool

The invention also provides a search tool. The search tool allows the user to search for terms in the file. The search tool also allows the user to search and list all occurrences of the term in the document. This search function provides the user with the ability to find the section of the file that is desired. For example, a chemical engineering textbook may use the term “heat exchanger” hundreds of times, but in the section where the calculation may be, the concentration of the term would be much higher. By having a listing of the occurrences, the user would not have to view every occurrence to find the section desired. In addition, the search tool may allow the user to view every occurrence of the term, plus surrounding words, or the sentence the term is used in, whatever the user chooses.

L. Highlight Manager

As mentioned within this document, the invention allows the user to highlight items. In addition, the invention allows the user to view sequentially all highlighted items in the file. This tool is very useful as a study aid. The invention also allows the user to expand any and all individual highlighted items to see the chapter, section, page, paragraph, or sentence that the item may be located in. This allows for a rapid refresher if the user is unsure of the meaning or context of the highlighted item. This invention allows for the user to change color of the highlight. At the users choice, he/she might use color-coded highlights to indicate different priorities or preferences. For example, a yellow highlight may indicate, “this is interesting” to the user and a blue highlight may indicate, “this will be on the test”.

M. Acronyms Manager

The invention, in addition to creating and displaying the structure tree, may create an acronym manager. An acronym manager searches the document for acronyms, generally all capital letters; or character, period, character, period type sequences; and creates a list of all acronyms in the file. In addition, the invention searches for the definition of the acronym, by looking at the first instance of the acronym in the file, or looking for a common acronym format, such as brackets immediately following an acronym. The acronym manager then links the acronym to the definition, allowing the user to view all the acronyms in the file, or when an acronym is encountered during reading the document, the invention may provide an indication on the acronym, which allows the user to view the definition if needed. The acronyms manager may also find and replace acronyms with the complete word structure that the acronym is created from. For example, NAM would be replaces with National Association of Manufacturers.

N. Icons Manager

The invention may also include an Icons Manager. The invention allows users to use a variety of icons and colors to identify and classify specific annotations. The Icons Manager is a tool that allows users to decode icons and colors by listing definitions for each. In its preferred embodiment, the Icons Manager is available for the user to see and use anywhere within the program and anywhere within a document. The Icons Manager can be attached to an annotations file, or it can be a stand-alone file. The Icons Manager can be shared between multiple users using any manner of file exchange technology.

O. Password or User Specific Viewing of Structured Elements in Documents

When a document is marked up, structure elements can be uniquely identified or within a hierarchy. The document can then be coded so that these structure elements are only visible to particular users or people with the appropriate password.

P. Mixed Graphic and Text File Viewing

There are no systems that show files in their respective text or graphic formats together. Included in this invention is a way to view files that shows each file in its proper format. For example, text files are shown with text file names, and graphic files (like picture or drawings) are shown as thumbnails with text name subtitles. The advantage of this mixture is that users can sort through files, visually, very quickly to find exactly the file they want.

Q. Product Development Structure Tree

This invention includes a Product Development Structure Tree that allows any company the capability of cataloging all of its past and present intellectual knowledge. Many organizations have numerous brainstorming sessions, failed product development projects, canceled projects, and reports that capture the results of the knowledge they have created and gained. These organizations do not have an easy way to access this knowledge, especially when employees who know where these reports are sitting have left the company. This portion of the invention requires the scanning of all company documents into PDF files (or other suitable ways to get the information into a computer file). This portion of the invention will then be used to search and catalog the vast information that exists within the company, but until now has only been available by finding the hard copies of needed documents. In effect, this tool allows the capturing of the knowledge that the organization has created and captured in written form. But most importantly, this portion of the invention will give organizations a way to access or leverage the information it has but can't easily find and use. This invention will enable the user to use, leverage and tap the knowledge that lies within the vast amount of information it has.

In essence, this portion of the invention would be considered a “knowledge management tool.” This invention would be a way for the user(s) to preserve the value of the knowledge created. In today's world, where employee turnover is rapid, this invention will enable an organization to maintain and utilize much of the knowledge it created and will create in the future.

Many companies develop good products and then learn that the market is not ready for the product. The invention described herein will ensure that the idea is not lost and is available when the time is right. This invention will have the capability to cross reference customer preferences, wants and desires so that as customer demands change, knowledge that the company has already created can be accessed and is available when the ‘time is right,’ based on these customer demands. There are many “patterns or trends” that can be identified in this world. For example there are buying patterns or trends, behavioral patterns, patterns of invention, weather patterns, etc. As customer wants and desires change or shift, or as someone identifies an emerging pattern(s), this portion of the invention will enable the user to identify or visualize blind spots or weaknesses it has in its product development plans. Use of templates will help users to be disciplined in the way they capture, display and search ideas for value. For example, if a food company has most of its current product development efforts focused on “sweet foods” and market research indicates that customer preferences are moving away from sweet foods, then the gap between what customers want and what the user is focused on is identified. This portion of the invention serves as a gap analysis tool that highlights blind spots in current product development efforts.

A company's information can be loaded into the template or structure tree as shown below.

### Generic Product Development Structure Tree

1. Why do consumers buy products/services?

2. New or emerging trends—Costumer Insights?

3. Product/service concept

New

Technical Development

No product available

Handmade product

Machine made product

Manufactured product

Manufactured in house

Manufactured by sub-contractor

Time to Market (estimated)

Less than 6 months

About 12 months

About 24 months

No estimate

Improvements/enhancements

Quality improvements

Speed improvements

Price improvements

Feature(s) improvements

Reliability improvements

Durability improvements

“Better for you” improvements

Different (This is not an improvement, it is a change to create new and different. Example: flavor change on potato chips)

Cost Reduction (Product/service remains the same but cost to produce/deliver goes down

Better utilization of technology

To improve quality

To improve cost

To improve service

4. Input/Raw Material Improvements

Ingredient improvement/enhancement

Cheaper

Better quality

Faster delivery

Reduce waste

Elimination

Substitution

5. Delivery Improvements/Enhancements

Faster

Timely

Reduction/elimination of damage

Cheaper transportation cost

Easier to move and store

Handling methods

Storage requirements

6. Technology Improvements/Enhancements

7. Protecting Competitive Advantage—Legal

Invention Disclosures

Patent Applications Filed

Technologies in Development

### VII. Expert Annotation

A. Expert Annotations (hereinafter EAs or EA) are pieces of information provided to further aid in the understanding of the underlying document. An example of an EA in a literature setting may be a short biography of the author, or the time period that the piece of literature was written in. An example of an EA in a legal setting may be the definition of a term of art, or a citation of a case that a statute may be codifying. An example of an EA in an engineering setting may be a spreadsheet with calculations to determine the flow profile in a pipe at a given set of system variables. EAs will be better understood given the following discussion. All annotations, personal, expert and other annotations, may be stored in files separate from the underlying document. This provides at least two benefits; first, the integrity of the underlying document is maintained at all times, and second, when the underlying document is large, such as the United States Tax Code, the annotation file may be transmitted to a second user whom has the underlying file but not the annotations without transmitting the underlying file.

EAs may have the capability to be “locked down” or made to be unchangeable by the user. When EAs have been written by an expert in a given field, this expert may want the assurance that the information that he/she has published via electronic medium will not be changed or altered by individual users.

B. There are several reasons to create expert annotations. Those reasons are:

1. To Explain and Simplify

Documents of inventions may be lengthy and complex. In many cases the documents may be written by lawyers and bureaucrats whose objective is “precision” rather than “clarity.” EAs can be written to shorten, simplify and summarize complex concepts. EAs may also take what was only a few words in the main document and expand them to explain their meaning and how they should be interpreted and applied.

2. To Enhance and Supplement

Publishers typically create two versions of textbooks: the students' version and the teachers' version. The teachers' version contains all that the students' version contains and includes answers to problems, suggested teaching methods, topics for discussion, supplemental materials and examples. Rather than creating two versions of a textbook, EAs can be used to add all the extras that would be in the teachers' version.

Cliff's Notes was and is a popular supplement to many great literary works of fiction. The content in Cliff's Notes could easily be done as EAs.

A technical book about thermodynamics contains many graphs that are based on mathematical equations, assumptions, variables and data. The examples in paper textbooks are “static” in that they cannot change. Students are given homework assignments that change the assumptions, which change the calculations, which change the graphs—all done using the textbook as a guide, but separate from the book. EAs could be created that link to already created spreadsheets that contain the thermodynamic graphs, and the equations, assumptions, variables and data that make the graphs. It is easy to see that being able to interact with a dynamic model while reading and studying would enhance learning.

Management books or articles that explain some theory about people may need annotations to tell personal stories about how the theory was applied or used in real life situations. In this case the annotations or personal stories may help the user to understand how the theory translates into real behaviors or actions.

Paper books and manuals can contain only the content that is between the covers and in only a single format—print. Weight and physical size may limit what can be included in a paper book or manual. Books and manuals of the invention know no such limitations. EAs can be used to link a document of the invention to web sites and web content, to supplemental articles, to video or audio clips, to photographs and even other books or plain PDFs of the invention.

3. To Offer Alternative Points of View

It is easy to imagine that some documents viewed using the invention will be controversial. EAs offer a way to present alternative points of view.

C. The Form of Expert Annotations

1. Text

2. “Static” Tables, Charts, Graphs, FIGS.

3. Video and Audio Clips

4. “Dynamic” Models and Worksheets

“Dynamic” models and worksheets is the activity of active spreadsheets and other similar modeling applications. Users will find great value in using dynamic models and worksheets created by content experts. Some examples:

A chemical engineering textbook utilizing the invention and that discusses the mathematics behind the design of heat exchangers could include an EA that links to a spreadsheet that contains a model for designing heat exchangers. Just plug in numbers for flow rates, heat capacities, heat transfer rates and temperatures, and the model calculates the design of the heat exchanger.

A textbook about finance utilizing the invention and that discusses the ratios that banks and investors use to value a business could include an EA that links to a spreadsheet that calculates ratios based on data input by the user.

5. Forms

6. Links to Other Content Resident on the User's Computer

“Other content resident on the user's computer” can mean other files utilizing the invention, files not utilizing the invention, dynamic models and worksheets based in other applications, and video and audio clips. Because dynamic models and video and audio clips are discussed separately, only links to other resident PDFs will be discussed here.

Links to other resident PDFs, utilizing the invention and not, are likely to be a common sort of EA that content experts will want to create.

Because links to files can be precisely controlled utilizing the invention, users can jump to precise locations within other files of the invention, and back again. Further, users can place personal annotations anywhere within files of the invention.

7. Links to Other Content Not-Resident on the User's Computer

Links to web sites and articles on reserve at electronic libraries will be another way that content experts create EAs. When a person reading an EA clicks on a link to non-resident content, control will transfer to the linked-to application running the non-resident content. When the user leaves the non-resident content, control will jump back to the EA.

D. How Expert Annotations will be Created

EAs may be created by content experts. EAs will probably not be created by software application experts (unless the subject matter is “software applications,” in which case they are content experts). Therefore, trying to specify a complicated development process to create EAs or demanding that content experts learn a new software application to create EAs will cause content experts to reject the concept of EAs.

Content experts will demand to use the software applications they are already familiar with to create EAs. Three separate tasks are required to create a document: a) typing in the content, b) editing and c) formatting. Typing in the content is pretty much the same, regardless of the software application used. The same is true of editing. However, formatting is an art form specific to each particular software application. It's not tough to sit down at an unfamiliar computer running an unfamiliar document creation program and figure out how to type in and then edit the content. Not so with formatting, especially if formatting requires creation of tables, charts and graphs. Formatting, even using a software application a person knows well, is a difficult and often frustrating task. Most people are not interested in learning to use a new software application to format EAs.

Therefore, content experts may create EAs in whatever software applications they already know and prefer to use. Further, because EAs will encompass such a broad range of different types of content, EAs may take a variety of forms. For conventional text, tables, figures and graphs, PDF will do nicely. For “dynamic models,” spreadsheets will be necessary. For complex mathematical modeling, other software applications will be used.

E. How Expert Annotations Will be Used

1. Read

2. Copy-and-Paste into Other Documents—With Citation Manager

Users may want to be able to copy and paste text, tables and graphics into other documents, all with correct citation reference. The invention, because it begins with an exact copy of the page, knows the page and line of the copied information. The invention provides a pop-up screen when a passage is selected for copying, which provides the user the ability to modify the type and format of the citation. The user is given the ability to order information such as author, title of work, page, publisher, etc., as required for the end use of the user. In addition to order, the user is give the opportunity to customize the format of the citation. For example, in the author field, the user may choose first name last, or first name first. The user can also choose if the author field is followed by a comma, period or other form of punctuation. In this way, the user is able to easily produce correct citations for any end use.

Once text is copied and pasted from EAs into another document, it can be edited. One way would be to copy and paste as a graphic rather than as text. Being able to copy and paste text as a graphic is a feature (lawyers, in particular, need this feature because they will want to copy and paste “exactly” as it looks). Being able to copy and paste text as fully editable text is also a feature.

Being able to copy text as fully editable text carries with it the responsibility on the part of the user to cite the source document.

3. Add Personal Annotations

EAs will range in length from the microscopic to the telescopic. Just as with any lengthy document of the invention, users may use personal annotations (notes and highlights) to condense, summarize and focus EAs.

In addition to being able to add personal annotations to EAs, users may be able to see which EAs have their personal annotations added to them, and to easily access those personal annotations without having to peel the onion through too many layers to find what they want.

4. Bookmarks

Bookmarks may be considered another form of personal annotation. Users don't expect to be able to see highlights or notes without turning to the page in the book that contains the highlights. However, users expect to be able to see a series of bookmarks in a stack of books as they sit, unopened, on a bookshelf And, if you know that the bookmark you are looking for is blue, you can scan across the row of books for the blue bookmark without even knowing which book it is in. Bookmarks are like homing beacons that let the person who created them navigate EXACTLY and DIRECTLY to that spot.

Users may be able to place bookmarks in EAs to guide them to exactly the place within the EA that they want to go.

To be really useful, when a user has a number of related documents utilizing the invention, bookmarks may be accessible without having to first open the books or documents in which they are placed.

5. Fill In Forms

Filling in forms may be a key benefit of and reason to use EAs.

6. Interact with “Dynamic” Models

Dynamic models may not be PDFs. They may be things like MS-Excel spreadsheets. Users who want to use EAs that are dynamic models may need the software application that runs the EA-linked file resident on their computers. If the dynamic model is an MS-Excel spreadsheet and the user does not have MS-Excel on his computer, the dynamic model may not run.

F. How Expert Annotations Will be Distributed

1. First-Use Distribution

i. With the Main Document

Distribution of EAs may occur with the main document. When the publisher of the main document also publishes the EAs, the two may be distributed together. The two pieces of content (each may contain many files) may be on CDs, or, if the user's Internet connection speed is fast enough, one or both could be a downloaded.

ii. Separate from the Main Document

There will be times—as when students purchase a product like Cliff's Notes for a book they are reading—when the publisher of EAs may be different from the publisher of the main document. In this case, EAs for a particular document may be purchased and distributed separately from the main document. When this happens, the invention provides a feature to “Import Expert Annotations.” It may occur that people may acquire more than one set of EAs from different publishers. To account for that possibility, the “Import Expert Annotations” function will provide a way to differentiate between sets of EAs.

There will be times when people may purchase EAs without purchasing the main document that the EAs support. It that case, the invention allows the EAs to be viewed without importing them into the main document they were written to explain or enhance.

2. Downloads

Updates—EAs may need to be changed as new information becomes available. In a legal setting, when a case gets overruled, EAs regarding the field may need to be updated. In the field of engineering, as new programs are developed, EAs may need to be modified to use the most powerful, up to date software. Additionally, EAs may need to be modified when a new expert in the field adds his or her input.

Making Obsolete EAs “Go Away”—EAs may be deleted when updates are available. If a section of the tax code is repealed, EAs relating to that section would become obsolete. For this reason, the author of the EAs may choose to have the EAs deleted with the update.

Archiving Obsolete EAs—Hard drives on PCs have gotten so large and so cheap that archiving obsolete EAs instead of deleting them is unlikely to create “out of storage capacity” problems.

An advantage to archiving obsolete EAs is that, users will have a complete evolutionary history of EAs for the main document. This may be a good thing, for example, with an expertly annotated Federal and State accessibility guideline based on the Americans With Disabilities Act. EAs for accessibility guidelines may change as interpretation and application of accessibility guidelines changes. Being able to go back to obsolete EAs to see how guidelines were interpreted several years ago and comparing that to today could be very important in legal cases. More than just important, maintaining a complete evolutionary history of EAs for a product sold on a subscription basis may be advantageous.

Another reason to archive obsolete EAs is that users will add their own personal annotations to particular EAs. If particular EAs with personal annotation are deleted, the personal annotations attached to it are problematic. If the obsolete EAs with a set of personal annotations attached is simply archived, then it is possible for the user to see the old personal annotations just by looking at the archived EAs. Assuming that there are similarities between the archived EAs and new replacement EAs, the invention provides a copy-and-paste feature to move personal annotations in the old EAs to the new EAs.

The invention may indicate that individual EAs are obsolete and let the user decide to keep, hide or delete the obsolete EAs.

Adding New EAs to New Parts of the Main Document—Adding new EAs to new parts of the main document is going to be a regular event.

The invention “signals” the user that particular EAs are new and have been added to the current EA configuration. This may be done through e-mail, Internet connection, or other manner known in the art.

Replacing Obsolete EAs with New EAs—Replacing obsolete EAs with new EAs is a combination of archiving obsolete EAs and adding new EAs.

The invention may “signal” that particular EAs are obsolete and have been replaced with new EAs, and that the obsolete EAs have been archived.

G. Separate File for EAs-only Icons

EAs may be identified by a special set of icons that are not accessible to the user to create personal annotations. This may be done by locating EA-only icons in a separate folder that is accessed only by the function that locates and contains the EA links. The icons that identify personal annotations may be located in a different file that is accessed only by the function that locates and contains personal annotations.

FIGS. 23, 24 and 25 show the navigation window

Label 200 shows portions of the outline that contain annotations.

Clicking the label 200 called Ch. 3_Building Blocks will expand the outline to show the annotations directly under this heading. The icon shown in label 200 changes to the icon in label 202, which shows a way to collapse the view to hide the annotations. Label 203 show three annotations that are found within chapter 3. Label 201, which is a plus sign. Clicking this expands the outline one structural level. The annotations 203 are redistributed under subordinate headings shown in label 205. It also redistributes the icon in label 202 to the three areas in 205. Label 201 also changes to a minus sign as shown in label 204. The minus sign represents that the structure level can be collapsed.

While the present invention has been described with respect to various specific embodiments and examples, it will be appreciated that a wide variety of modifications, adaptations and derivations may be made which are within the spirit and scope of the present invention as defined by the following claims and equivalents thereof.

What is claimed is:

1. A method for viewing electronic information comprising the steps of: displaying in a first window a physical page from an electronic document containing information from a predefined page format, wherein the electronic document comprises representations of at least one physical page, and a visual reference emphasizing information on the at least one physical page, extracting the information emphasized by the visual reference on the at least one physical page, presenting the extracted information in a second window and presenting a navigation tool in a third window.

2. The method of claim 1 wherein the physical page is represented in an electronic page view.

3. The method of claim 1 wherein the physical page is represented as an icon including a thumbnail of the physical page.

4. The method of claim 1 wherein the first and second window are the same window.

5. The method of claim 1 wherein the second window is an enhanced interactive window including a thumbnail image of a physical page, a graphic image of a physical page, text, free flowing text, icons, hyperlinks, menus, and control elements.

6. The method of claim 1 wherein the navigation tool presents an extraction of content and annotations.

7. The method of claim 6 wherein the step of selecting further comprises the step of enclosing the annotation with a box.

8. The method of claim 1 wherein the second window may be placed in various positions relative to the first window, including on top of the first window, adjacent to the first window, and partially covering the first window.

9. The method of claim 1 wherein the second window further comprises a control panel for managing the extracted information.

10. The method of claim 1 wherein the extracted information may be viewed simultaneously in a multiple of enhanced interactive windows.

11. A computer system for viewing electronic information, the electronic information comprising textual and graphic data of electronic books and documents, the system comprising: an information manager for manipulating graphic images of physical pages and annotations bounding electronic information from the physical pages, an enhanced interactive window for displaying the electronic information, and a navigation tool for manipulating the electronic information in a third window.

12. The system of claim 11 wherein the enhanced interactive window comprises at least one window that displays extracted information from the physical pages.

13. The system of claim 11 wherein the enhanced interactive window includes a thumbnail image of a physical page, a graphic image of a physical page, text, free flowing text, icons, hyperlinks, menus, and control elements.

14. The system of claim 11 wherein the information manager further comprises a database for storing annotations, extracted electronic information, and the relationships in the system.

15. The system of claim 11 wherein the database includes a structure tree for storing relationship information associating electronic information with extracted electronic information.

16 The system of claim 11 wherein a visual reference emphasizing the electronic information is displayed on the physical pages.

17. The system of claim 11 wherein the annotations and the electronic information are stored in separate files.

18. The system of claim 11 further comprising a scroll bar based on logical increments.

19. The system of claim 11 further comprising an acronyms manager, a citation manager, an icons manager, or style manager.

20. A computer system for viewing electronic information, the system comprising: a visual display for displaying an enhanced interactive window and a navigation window based upon electronic information in a page description format; a storage medium for storing and retrieving information related to the electronic information in the page description format; a computer processor coupled to the visual display and to the storage medium for accessing and processing information stored in the storage medium to provide a display of the enhanced interactive window and the navigation window; an input means coupled to the computer processor for entering information related to the electronic information in the page description format; a software portion for creating a plurality of relationships between the enhanced interactive window, the navigation window, and the electronic information in the page description format; and a software portion for providing a graphical user interface for navigation and display.
